(19) United States
(12) Patent Application Publication
(10) Pub. No.: US 2026/0280733 A1
(43) Pub. Date: Sep. 17, 2026

(54) WI-FI SIGNAL-BASED COPRESENCE ESTIMATION METHOD AND DEVICE

(71) Applicant: SAMSUNG ELECTRONICS CO., LTD., Suwon-si (KR)

(72) Inventors: Chanjong PARK, Suwon-si (KR); Dongha BAHN, Suwon-si (KR); Junik JANG, Suwon-si (KR)

(73) Assignee: SAMSUNG ELECTRONICS CO., LTD., Suwon-si (KR)

(21) Appl. No.: 19/669,329

(22) Filed: May 6, 2026

Related U.S. Application Data
(63) Continuation of application No. PCT/KR2024/015100, filed on Oct. 4, 2024.

(30) Foreign Application Priority Data
Nov. 17, 2023 (KR) 10-2023-0159709

(51) Int. Cl. H04B 17/318; H04W 64/00; H04W 84/12

(52) U.S. Cl. CPC H04B 17/318; H04W 64/006; H04W 84/12

(57) ABSTRACT

An embodiment may provide a method including: obtaining a first Wi-Fi RSSI corresponding to Wi-Fi networks communicable with the user device; obtaining second Wi-Fi RSSIs corresponding to Wi-Fi networks communicable with other devices; estimating, by applying the first Wi-Fi RSSI and the second Wi-Fi RSSIs as input data to a copresence estimation model, an estimation result indicating whether the other devices are present in a same space as the user device; receiving feedback based on the estimation result; generating, based on the feedback, a feedback dataset including the first and second Wi-Fi RSSIs; obtaining a pre-collected first Wi-Fi RSSI corresponding to the Wi-Fi networks communicable with the user device; obtaining pre-collected second Wi-Fi RSSIs corresponding to the Wi-Fi networks communicable with the other devices; generating, by filtering the pre-collected first and second Wi-Fi RSSIs, a filtered dataset; and updating, based on the feedback and filtered datasets, the copresence estimation model.

### CROSS-REFERENCE TO RELATED APPLICATION(S)

This application is a continuation of International Application No. PCT/KR2024/015100 filed on Oct. 4, 2024, which claims priority to Korean Patent Application No. 10-2023-0159709 filed on Nov. 17, 2023 in the Korean Intellectual Property Office, the disclosures of which are incorporated by reference herein in their entirety.

### BACKGROUND

The present disclosure relates to a method and device for estimating copresence between devices based on Wi-Fi signals, and optimizing an artificial intelligence (AI) model for estimating copresence.

Technologies utilizing Wi-Fi signals have been used to estimate locations of devices in indoor environments. In addition, as artificial intelligence is utilized in various fields, artificial intelligence may also be applied to technologies for estimating locations of devices in indoor environments. However, even when artificial intelligence is used, because inference results may be inaccurate depending on diverse environments of users, the inference results may not always be reliable. To this end, although user feedback may be used as training data, it is still difficult to secure training data suitable for a user's environment based on the user feedback alone.

### SUMMARY

One or more embodiments of the present disclosure may provide a method of operating a user device, the method including: obtaining a first Wi-Fi Received Signal Strength Indicator (RSSI) corresponding to one or more Wi-Fi networks that are in position to communicate with the user device; obtaining a plurality of second Wi-Fi RSSIs corresponding to one or more Wi-Fi networks that are in position to communicate with one or more other devices; estimating, by applying the first Wi-Fi RSSI and the plurality of second Wi-Fi RSSIs as input data to a copresence estimation model, an estimation result that indicates whether the one or more other devices are present in a same space as the user device; receiving feedback based on the estimation result; generating, based on the feedback, a feedback dataset including the first Wi-Fi RSSI and the plurality of second Wi-Fi RSSIs; obtaining a pre-collected first Wi-Fi RSSI corresponding to the one or more Wi-Fi networks that are in position to communicate with the user device; obtaining a plurality of pre-collected second Wi-Fi RSSIs corresponding to the one or more Wi-Fi networks that are in position to communicate with the one or more other devices; generating, by filtering the pre-collected first Wi-Fi RSSI and the plurality of pre-collected second Wi-Fi RSSIs according to preset conditions, a filtered dataset; and updating, based on the feedback dataset and the filtered dataset, the copresence estimation model.

One or more embodiments of the present disclosure may provide a user device including: a communication interface; memory storing one or more instructions; and one or more processors configured to execute, individually or collectively, the one or more instructions stored in the memory, wherein the one or more processors are configured to execute the one or more instructions to: obtain a first Wi-Fi Received Signal Strength Indicator (RSSI) corresponding to one or more Wi-Fi networks that are in position to communicate with the user device, obtain a plurality of second Wi-Fi RSSIs corresponding to one or more Wi-Fi networks that are in position to communicate with one or more other devices, estimate, by applying the first Wi-Fi RSSI and the plurality of second Wi-Fi RSSIs as input data to a copresence estimation model, an estimation result that indicates whether the one or more other devices are present in a same space as the user device, receive feedback based on the estimation result, generate, based on the feedback, a feedback dataset including the first Wi-Fi RSSI and the plurality of second Wi-Fi RSSIs, obtain a pre-collected first Wi-Fi RSSI corresponding to the one or more Wi-Fi networks that are in position to communicate with the user device; obtain a plurality of pre-collected second Wi-Fi RSSIs corresponding to the one or more Wi-Fi networks that are in position to communicate with the one or more other devices, generate, by filtering the pre-collected first Wi-Fi RSSI and the plurality of pre-collected second Wi-Fi RSSIs according to preset conditions, a filtered dataset, and update, based on the feedback dataset and the filtered dataset, the copresence estimation model.

### BRIEF DESCRIPTION OF DRAWINGS

FIG. 1 is a diagram illustrating an operation, performed by a user device, of estimating a location thereof indoors, according to one or more embodiments of the present disclosure.

FIG. 2 is a diagram illustrating an operation of personalizing an artificial intelligence model for estimating whether a user device is present in a same space as another device, according to one or more embodiments of the present disclosure.

FIG. 3 is a diagram illustrating an operation of a copresence estimation model used by a user device, according to one or more embodiments of the present disclosure.

FIG. 4A is a diagram illustrating an operation, performed by a user device, of obtaining feedback on a result of copresence estimation, according to one or more embodiments of the present disclosure.

FIG. 4B is a diagram illustrating an operation, performed by a user device, of generating feedback data, according to one or more embodiments of the present disclosure.

FIG. 5A is a diagram illustrating data collection operations of a user device and another device according to one or more embodiments of the present disclosure.

FIG. 5B is a diagram illustrating an operation, performed by a user device, of generating a filtered dataset, according to one or more embodiments of the present disclosure.

FIG. 6 is a diagram illustrating a training dataset generated by a user device, according to one or more embodiments of the present disclosure.

FIG. 7A is a flowchart illustrating an operating method of a user device when receiving feedback, according to one or more embodiments of the present disclosure.

FIG. 7B is a flowchart illustrating an operation of FIG. 7A in more detail.

FIG. 8 is a diagram illustrating an operation, performed by a user device, of generating a training dataset, according to one or more embodiments of the present disclosure.

FIG. 9 is a diagram illustrating an operation, performed by a user device, of generating a training dataset, according to one or more embodiments of the present disclosure.

FIG. 10 is a diagram illustrating an operation, performed by a user device, of using a copresence estimation model, according to one or more embodiments of the present disclosure.

FIG. 11 is a block diagram illustrating a configuration of a user device according to one or more embodiments of the present disclosure.

### DETAILED DESCRIPTION

All of the embodiments of the disclosure described herein are example embodiments, and thus, the disclosure is not limited thereto, and may be realized in various other forms. Each of the embodiments provided in the following description is not excluded from being associated with one or more features of another example or another embodiment also provided herein or not provided herein but consistent with the disclosure.

It will be understood that when an element, component, layer, pattern, structure, region, or so on (hereinafter collectively “element”) of a semiconductor device is referred to as being “over,” “above,” “on,” “below,” “under,” “beneath,” “connected to” or “coupled to” another element of the semiconductor device, it can be directly over, above, on, below, under, beneath, connected or coupled to the other element or an intervening element(s) may be present. In contrast, when an element of a semiconductor device is referred to as being “directly over,” “directly above,” “directly on,” “directly below,” “directly under,” “directly beneath,” “directly connected to” or “directly coupled to” another element of the semiconductor device, there are no intervening elements present.

As used herein, the term “and/or” includes any and all combinations of one or more of the associated listed items. As used herein, expressions such as “at least one of,” when preceding a list of elements, modify the entire list of elements and do not modify the individual elements of the list. For example, the expression, “at least one of a, b and c,” and “at least one of a, b, or c” should be understood as including only a, only b, only c, both a and b, both a and c, both b and c, or all of a, b and c.

It will be also understood that, even if a certain step or operation of manufacturing an apparatus or structure is described later than another step or operation, the step or operation may be performed later than the other step or operation unless the other step or operation is described as being performed after the step or operation.

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

The embodiments of the disclosure described in the present specification and the drawings are only presented as specific examples to easily explain the technical content according to the embodiments of the disclosure and help understanding of the embodiments of the disclosure, not intended to limit the scope of the embodiments of the disclosure. Therefore, the scope of one or more embodiments of the disclosure should be construed as encompassing all changes or modifications derived from the technical spirit of one or more embodiments of the disclosure in addition to the embodiments disclosed herein.

It will be understood that, although the terms “first”, “second”, “third”, “primary”, “secondary”, “tertiary”, etc., may be used selectively or interchangeably herein to describe various elements, but elements are not limited by these terms. These terms are only used to distinguish one element from another element. For example, without departing from the scope of the disclosure, a first element may be termed as a second element, and a second element may be termed as a first element.

When an element (e.g., a first element) is referred to as being “(functionally or communicatively) coupled” or “connected” to another element (e.g., a second element), the first element may be connected to the second element, directly (e.g., wired), wirelessly, or through a third element.

In this disclosure, the terms “containing”, “including”, “comprising”, “having”, and the like are used to specify features, numbers, steps, operations, elements, components, or combinations thereof, but do not preclude the presence or addition of one or more of the features, numbers, steps, operations, elements, components, or combinations thereof.

In addition, in the present disclosure, the meaning of “identical” includes cases where properties are similar to each other or similar within a certain range. Furthermore, unless clearly indicated, stated, and/or shown otherwise; as used herein the terms “identical”, “uniform”, “equal”, and/or “the same” may mean “substantially identical”, “substantially uniform”, “substantially equal”, “about the same”, “equal to about”, and/or “substantially the same”. The meaning of substantially identical should be understood to include numerical values within manufacturing error ranges, machining or processing tolerances, and/or differences within a range that is so insignificant such that neither the structure nor function of the embodiments disclosed herein are materially altered, inhibited, or destroyed.

Furthermore, although one or more embodiments may comprise the disclosed features as described herein—as well as additional features not specifically described—other embodiments may instead be completely free of non-disclosed elements. For example, non-disclosed elements may be completely omitted from one or more embodiments of the present disclosure.

As used herein, the terms “front (or forward)”, “rear (or back, backward, rearward)”, “up (or upper, top, above)”, “down (or lower, bottom, below)”, “left”, “right”, and the like may be defined with reference to the drawings, and may not be intended to limit the shape and/or position of each component.

The terms used in the present disclosure are selected from among currently widely used general terms by taking into consideration the functions thereof in the present disclosure, but the terms may vary depending on the intention of one of ordinary skill in the art, precedents, or the emergence of new technologies. In addition, in certain cases, terms arbitrarily selected by the applicant may be used, and in such cases, the meanings thereof will be described in detail in the relevant description section. Therefore, the terms used in the present disclosure should be defined based on the meanings of the terms and the overall content of the present disclosure, rather than simply based on the names of the terms.

As used in connection with the disclosure, the terms “module” or “unit” may include a unit implemented in hardware (i.e., structure), software, or firmware, and may interchangeably be used with other terms such as: portion, part, unit, member, logic, logic block, part, or circuitry. A module may be a single integral component, or a minimum unit or part thereof, adapted to perform one or more functions. For example, according to one or more embodiments, the module may be implemented in a form of an application-specific integrated circuit (ASIC). Depending on the embodiment(s), a plurality of “modules” may be implemented as a single element, or a single “module” may include a plurality of elements, and may comprise a device structure and/or apparatus structure.

One or more embodiments as set forth herein may be implemented as software including one or more instructions that are stored in a storage medium that is readable by a machine. For example, a processor of the machine may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

A method according to one or more embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to one or more embodiments, each component (e.g., a module or a program) of the above-described components may include a single entity or multiple entities. According to one or more embodiments, one or more of the above-described components may be omitted, or one or more other components may be added. Alternatively or additionally, a plurality of components (e.g., modules or programs) may be integrated into a single component. In such a case, according to one or more embodiments, the integrated component may still perform one or more functions of each of the plurality of components in the same or similar manner as they are performed by a corresponding one of the plurality of components before the integration. According to one or more embodiments, operations performed by the module, the program, or another component may be carried out sequentially, in parallel, repeatedly, or heuristically, or one or more of the operations may be executed in a different order or omitted, or one or more other operations may be added.

According to one or more embodiments, in a non-volatile storage medium storing instructions, the instructions may be configured to, when executed by at least one processor, cause the at least one processor to perform at least one operation. The at least one operation may include displaying an application screen of a running application on a display, identifying a data input field included in the application screen, identifying a data type corresponding to the data input field, displaying at least one external electronic device, around the electronic device, capable of providing data corresponding to the identified data type, receiving data corresponding to the identified data type from an external electronic device selected from among the at least one external electronic device through a communication module, and entering the received data into the data input field.

Hereinafter, embodiments of the present disclosure will be described in detail with reference to the accompanying drawings such that one of ordinary skill in the art may easily implement the present disclosure. However, the present disclosure may be implemented in many different forms and is not limited to the embodiments described herein. In addition, in the drawings, parts unrelated to the description may be omitted in order to clearly describe the present disclosure, and like elements may be denoted by like reference numerals throughout the specification.

Hereinafter, the present disclosure will be described with reference to the accompanying drawings.

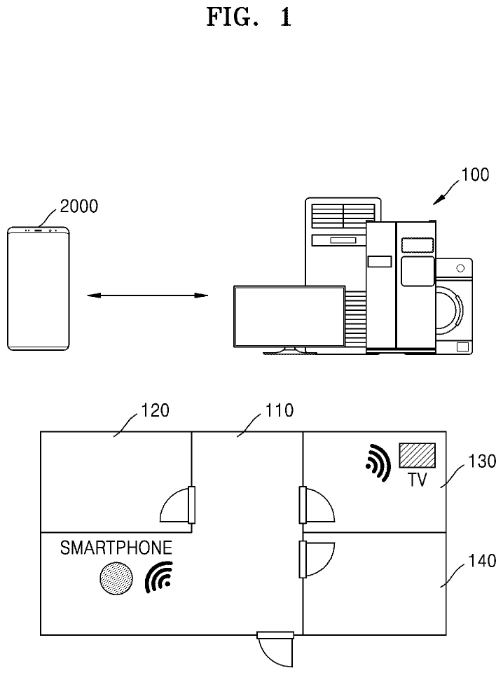

FIG. 1 is a diagram illustrating an operation, performed by a user device, of estimating a location thereof indoors, according to one or more embodiments of the present disclosure.

Referring to FIG. 1, a user device 2000 according to one or more embodiments may estimate a relative location thereof with respect to a plurality of other devices 100 indoors. For example, the user device 2000 may estimate whether the user device 2000 is located in the same space as or a different space from each of the other devices 100.

In one or more embodiments, the term “space” may refer to a three-dimensional environment that is physically separated by a spatial layout (e.g., floors, walls, pillars, ceilings, etc.). For example, assuming a user's home environment, a room A 110, a room B 120, a room C 130, and a living room 140 may each be referred to as a space. In the example of FIG. 1, when a smartphone is in the living room 140 and a TV is in Room B 120, the smartphone and the TV may be regarded as being present in different spaces.

In one or more embodiments, the user device 2000 and the other devices 100 may be communicatively connected to interact with each other. For example, the user device 2000 and the other devices 100 may be connected to the same network (e.g., home Wi-Fi). Alternatively, the user device 2000 and the other devices 100 may be connected to the same server (e.g., a cloud server), but are not limited thereto.

The user device 2000 may include various types of devices. For example, the user device 2000 may be a mobile device such as a tablet PC or a smartphone. The other devices 100 may include various types of devices. The other devices 100 may include, for example, various home appliances such as washing machines, dryers, vacuum cleaners, robot vacuum cleaners, air conditioners, clothes managers, air purifiers, and dishwashers, but are not limited thereto. In one or more embodiments, a user may use the user device 2000 to manage and control the other devices 100. The user device 2000 may receive a user input and, based on the received user input, request information from the plurality of other devices 100 or control the plurality of other devices 100.

In one or more embodiments, the user device 2000 may estimate whether the other devices 100 are present in the same space as the user device. In this case, the user device 2000 may estimate copresence or non-copresence between devices by using a copresence estimation model, which is an artificial intelligence model. The user device 2000 may optimize the copresence estimation model to suit a user space. To optimize the copresence estimation model, the user device 2000 may collect and process data to generate training data.

Specific operations, performed by the user device 2000, of collecting data for training the copresence estimation model and fine-tuning the copresence estimation model will be described in more detail through the drawings and descriptions thereof provided below.

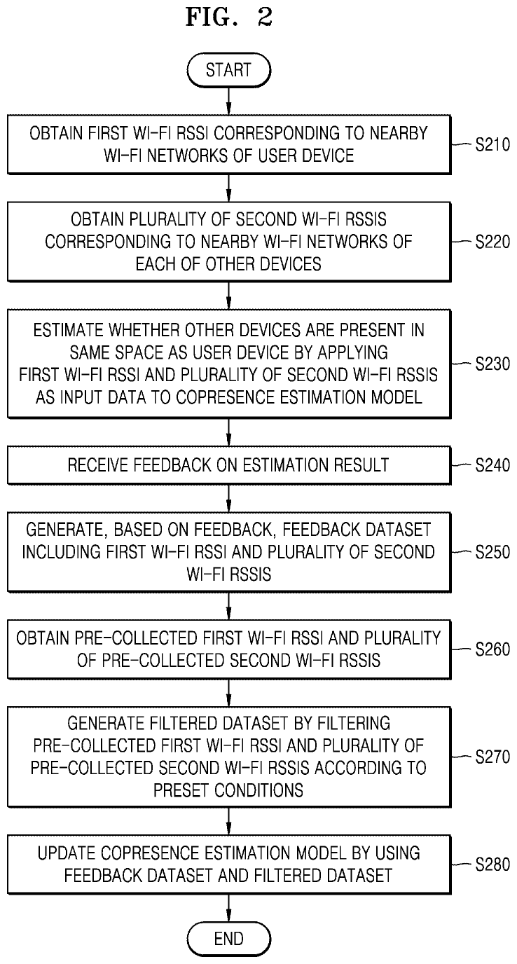

FIG. 2 is a diagram illustrating an operation of personalizing an artificial intelligence model for estimating whether a user device is present in a same space as another device, according to one or more embodiments of the present disclosure.

In operation S210, the user device 2000 may obtain a Wi-Fi RSSI corresponding to nearby Wi-Fi networks of the user device 2000. In the present disclosure, a Wi-Fi RSSI received by the user device 2000 may be referred to as a first Wi-Fi RSSI. Herein, a Wi-Fi network may be considered to be nearby a device if the Wi-Fi network (or an access point thereof) is, relative to the device, located in a position and/or space such that the Wi-Fi network is able to communicably connect to or with the device.

In one or more embodiments, the user device 2000 may obtain an RSSI value indicating the reception strength of a Wi-Fi signal received through communication circuitry (e.g., a Wi-Fi card, etc.) included in the communication interface. An RSSI may be a value expressed in units of dBm.

In one or more embodiments, when a plurality of Wi-Fi routers or wireless access points (APs) are present near the user device 2000, a plurality of RSSI values may be provided. For example, an RSSI may be a sequence of values respectively corresponding to nearby Wi-Fi networks.

In operation S220, the user device 2000 may obtain a plurality of Wi-Fi RSSIs corresponding to nearby Wi-Fi networks of each of other devices. In the present disclosure, a Wi-Fi RSSI received by a device other than the user device 2000 may be referred to as a second Wi-Fi RSSI. In other words, in order to distinguish a Wi-Fi RSSI of the user device 2000 from a Wi-Fi RSSI of any other device, the Wi-Fi RSSI of the user device 2000 will be referred to as the first Wi-Fi RSSI, and the Wi-Fi RSSI of any other device will be referred to as the second Wi-Fi RSSI. However, both the first Wi-Fi RSSI and the second Wi-Fi RSSI essentially refer to a Wi-Fi RSSI typically obtained by a device.

In one or more embodiments, the number of other devices may be two (2) or more. For example, the user device 2000 may receive, from a device A that is another device, a Wi-Fi RSSI of the device A, and receive, from a device B that is another device, a Wi-Fi RSSI of the device B. In other words, the user device 2000 may obtain a plurality of second Wi-Fi RSSIs respectively corresponding to the other devices. Continuing with the above-described example, the plurality of second Wi-Fi RSSIs may include the Wi-Fi RSSI of the device A and the Wi-Fi RSSI of the device B.

In operation S230, the user device 2000 may estimate whether the other devices are present in the same space as the user device 2000 by applying the first Wi-Fi RSSI and the plurality of second Wi-Fi RSSIs as input data to a copresence estimation model.

In one or more embodiments, the copresence estimation model may be an artificial intelligence model trained to receive Wi-Fi RSSIs of two devices as input and estimate whether the two devices are present in the same space.

The user device 2000 may input, into the copresence estimation model, input data including the first Wi-Fi RSSI and the second Wi-Fi RSSI. The plurality of second Wi-Fi RSSIs include Wi-Fi RSSIs of respective devices other than the user device 2000. For example, the plurality of second Wi-Fi RSSIs may include the Wi-Fi RSSI of the device A and the Wi-Fi RSSI of the device B. For example, the user device 2000 may input, into the copresence estimation model, the Wi-Fi RSSI of the device A among the first Wi-Fi RSSI and the plurality of second Wi-Fi RSSIs to estimate whether the device A is present in the same space as the user device 2000. In addition, for example, the user device 2000 may input, into the copresence estimation model, the Wi-Fi RSSI of the device B among the first Wi-Fi RSSI and the plurality of second Wi-Fi RSSIs to estimate whether the device B is present in the same space as the user device 2000.

In operation S240, the user device 2000 may receive feedback on a result of the estimation. The user device 2000 may obtain, from the user, a user input for inputting feedback.

In one or more embodiments, the feedback may include positive feedback. The positive feedback may indicate that the result of the estimation of the copresence estimation model is accurate. For example, the user device 2000 may estimate that the device A is present in the same space as the user device 2000, or may estimate that the device A is present in a different space. When the result of the estimation of the user device 2000 is accurate, the user may input a user input indicating positive feedback.

In one or more embodiments, the feedback may include negative feedback. The negative feedback may indicate that the result of the estimation of the copresence estimation model is inaccurate. For example, the user device 2000 may estimate that the device B is present in the same space as the user device 2000, or may estimate that the device B is present in a different space. When the result of the estimation of the user device 2000 is inaccurate, the user may input a user input indicating negative feedback.

In one or more embodiments, the user device 2000 may request feedback from the user. For example, the user device 2000 may output a result of estimating whether the user device 2000 and another device (e.g., the device A and/or the device B) are present in the same space, and execute a feedback request function for requesting accuracy/inaccuracy of the result of the estimation. In response to a feedback request, the user device 2000 may obtain a user input for inputting feedback on a result of estimating copresence or non-copresence.

In one or more embodiments, the user device 2000 may be a mobile device (e.g., a smartphone, etc.). In addition, the other devices may be devices with relatively low mobility (e.g., TVs, etc.). Accordingly, location information (e.g., a room A, a room B, a living room, etc.) of another device may be pre-stored therein. The location information of the other device may be input by the user. In one or more embodiments, the feedback may include location information of the user device 2000. The user device 2000 may receive current location information (e.g., a room A, a room B, a living room, etc.) of the user device 2000. The current location information of the user device 2000 may be used to match with the location information of the other device.

In operation S250, the user device 2000 may generate, based on the feedback, a feedback dataset including the first Wi-Fi RSSI and the plurality of second Wi-Fi RSSIs.

In one or more embodiments, the user device may generate a data pair to be included in the feedback dataset, based on the result of the estimation obtained in operation S230 and the user feedback obtained in operation S240. For example, the user device 2000 may generate a positive pair, which is a data pair indicating that another device is present in the same space as the user device 2000. In addition, for example, the user device 2000 may generate a negative pair, which is a data pair indicating that another device is present in a different space from the user device 2000.

In other words, the feedback dataset may include a plurality of data pairs each including {first Wi-Fi RSSI, second Wi-Fi RSSI}, and each data pair may be annotated with information indicating whether devices are present in the same space or in different spaces.

In operation S260, the user device 2000 may obtain a pre-collected first Wi-Fi RSSI and a plurality of pre-collected second Wi-Fi RSSIs.

The pre-collected first Wi-Fi RSSI may be collected periodically or aperiodically from the user device 2000. The plurality of pre-collected second Wi-Fi RSSIs may be collected periodically or aperiodically from the other devices. For example, the plurality of pre-collected second Wi-Fi RSSIs may include a Wi-Fi RSSI pre-collected from the device A and a Wi-Fi RSSI pre-collected from the device B. The user device 2000 may receive a pre-collected second Wi-Fi RSSI from each of the other devices.

In one or more embodiments, operation S260 may be performed only when the feedback of operation S240 is received. The user device 2000 may perform operation S260 in response to obtaining the feedback. Based on obtaining the feedback, the user device 2000 may update the copresence estimation model by performing operations S270 to S280 described below.

In operation S270, the user device 2000 may generate a filtered dataset by filtering the pre-collected first Wi-Fi RSSI and the plurality of pre-collected second Wi-Fi RSSIs according to preset conditions.

In one or more embodiments, the user device 2000 may apply the pre-collected first Wi-Fi RSSI and the plurality of pre-collected second Wi-Fi RSSIs as input data to the copresence estimation model. By using the copresence estimation model, the user device 2000 may estimate whether another device was present in the same space as the user device 2000 at a time point when a Wi-Fi RSSI was collected. For example, the user device 2000 may input, into the copresence estimation model, the Wi-Fi RSSI of the device A among the pre-collected first Wi-Fi RSSI and the plurality of pre-collected second Wi-Fi RSSIs to estimate whether the device A was present in the same space as the user device 2000 at a corresponding time point. In addition, for example, the user device 2000 may input, into the copresence estimation model, the Wi-Fi RSSI of the device B among the pre-collected first Wi-Fi RSSI and the plurality of pre-collected second Wi-Fi RSSIs to estimate whether the device B was present in the same space as the user device 2000 at a corresponding time point.

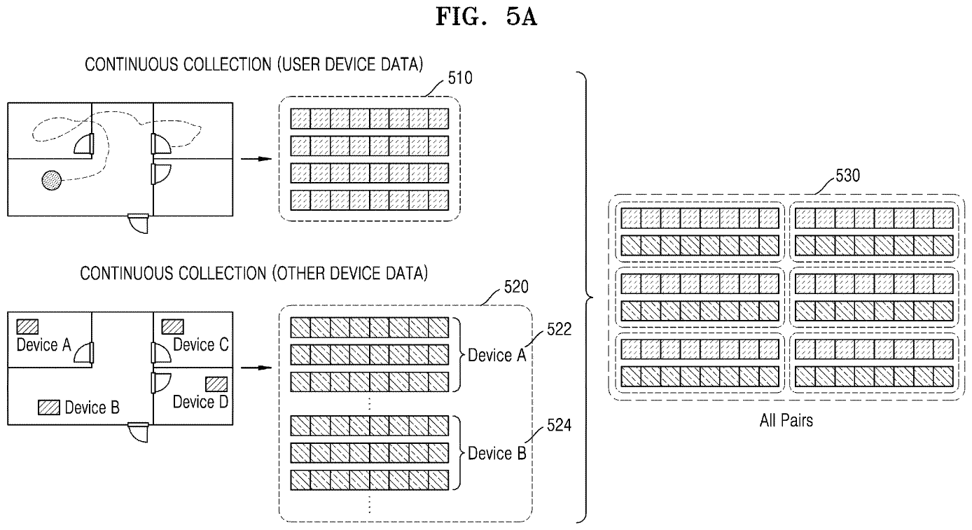

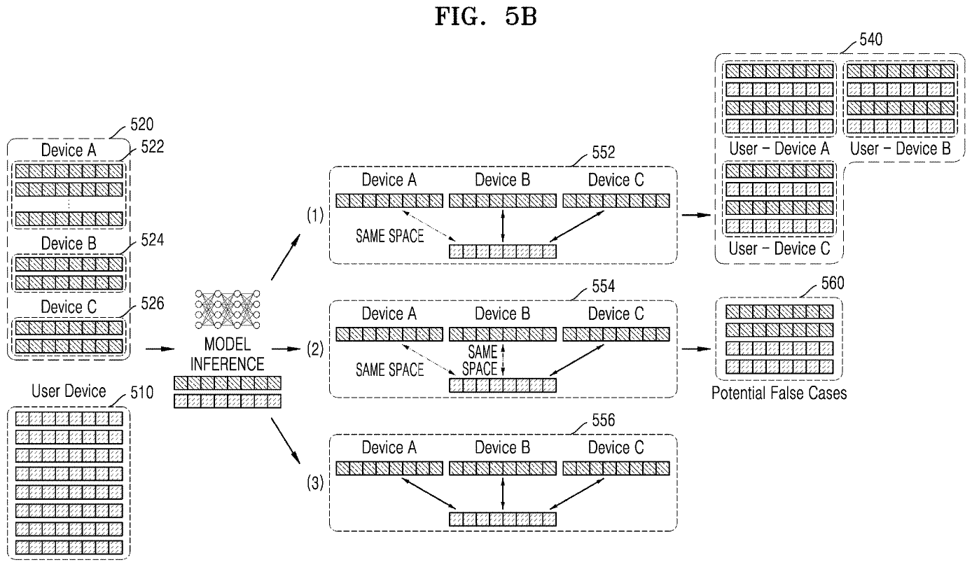

In one or more embodiments, the preset conditions, according to which the user device 2000 filters data, may be defined based on the number of devices present in the same space as the user device 2000. The user device 2000 may determine, based on the number of devices estimated to be present in the same space as the user device, among the other devices, whether to filter the pre-collected first Wi-Fi RSSI and the plurality of pre-collected second Wi-Fi RSSIs. The pre-set condition will be further described in the description of FIGS. 5A and 5B.

The user device 2000 may generate the filtered dataset by filtering out bad data and leaving only good data, among the pre-collected first Wi-Fi RSSI and the plurality of pre-collected second Wi-Fi RSSIs. The filtered dataset may include a plurality of data pairs each including {first Wi-Fi RSSI, second Wi-Fi RSSI}, and each data pair may be annotated with information indicating whether devices are present in the same space or in different spaces.

In operation S280, the user device 2000 may update the copresence estimation model by using the feedback dataset and the filtered dataset.

In one or more embodiments, the feedback dataset and the filtered dataset include Wi-Fi RSSIs collected within the user's space. The user device 2000 may fine-tune the copresence estimation model by using the feedback dataset and the filtered dataset as training datasets. The user device 2000 may increase the accuracy of copresence estimation within the user's space by using the feedback dataset for training. In this regard, for the feedback data, it is difficult to secure a large amount of data, and it may take a long time to secure a sufficient amount of data. By using the filtered dataset, which may supplement the feedback dataset, for training, the user device 2000 may increase the accuracy of the copresence estimation model while allowing the feedback to be reflected early.

In one or more embodiments, the user device 2000 may assign a higher weight to the feedback dataset than the filtered dataset. The user device 2000 may update the copresence estimation model by using the weight such that the feedback data of an insufficient amount is reflected with a higher proportion.

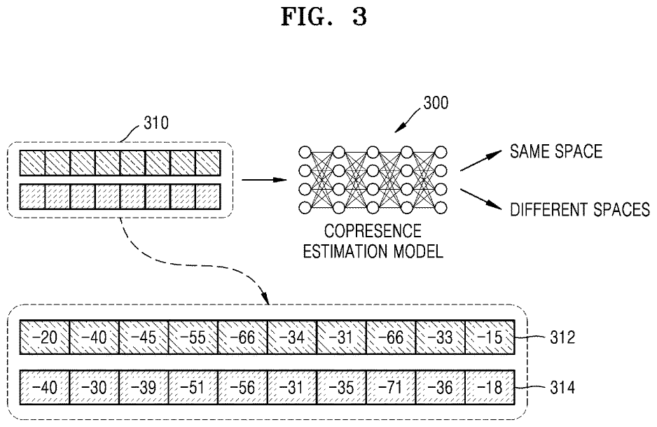

FIG. 3 is a diagram illustrating an operation of a copresence estimation model used by a user device, according to one or more embodiments of the present disclosure.

In the present disclosure, the term “model” refers to a copresence estimation model 300, unless otherwise stated. The copresence estimation model 300 may be an artificial intelligence model trained to receive input data 310 including pairs of data from two different devices and output a result of estimating whether the two different devices are present in the same space or in different spaces.

Referring to FIG. 3, the user device 2000 may perform an inference operation by inputting the input data 310 into the copresence estimation model 300.

In one or more embodiments, the input data 310 may include a first Wi-Fi RSSI 312 and a second Wi-Fi RSSI 314. The first Wi-Fi RSSI 312 may correspond to nearby Wi-Fi networks of the user device 2000, and the second Wi-Fi RSSI 314 may correspond to nearby Wi-Fi networks of another device. In the example of FIG. 3, the first Wi-Fi RSSI 312 indicates the strengths of signals received by the user device 2000 from each of ten wireless APs near the user device 2000, and the second Wi-Fi RSSI 314 indicates the strengths of signals received by the other device from each of ten wireless APs near the other device. The user device 2000 may input the input data 310 including the first Wi-Fi RSSI 312 and the second Wi-Fi RSSI 314 into the copresence estimation model 3000 to estimate whether the user device 2000 and the other device are present in the same space. In this case, Wi-Fi RSSIs of each pair used for copresence estimation may be obtained from respective devices in the same time period.

In one or more embodiments, the copresence estimation model 300 may be implemented using a deep neural network architecture and algorithm of artificial intelligence for performing a classification task, or may be implemented through modification of a known deep neural network architecture and algorithm of artificial intelligence. For example, the copresence estimation model 300 may be implemented through a deep neural network model including one or more multi-layer perceptrons (MLPs) including layers including weights, and may be implemented through a deep neural network model based on a transformer architecture including an attention mechanism, but is not limited thereto.

In one or more embodiments, the copresence estimation model 300 may be a pre-trained model. The copresence estimation model 300 may be trained using correct data including Wi-Fi RSSI data pairs. The correct data may be annotated with information indicating whether two devices are present in the same space. In this case, a Wi-Fi RSSI data pair labeled as “same space” may be referred to as a positive pair, and a Wi-Fi RSSI data pair labeled as “different spaces” may be referred to as a negative pair.

The term “pre-trained model” may be referred to by various expressions indicating the same or similar concepts. For example, the pre-trained model may be referred to by expressions such as “base model,” “pre-fine-tuning model,” and “pre-update model,” but is not limited to the above-described examples.

In one or more embodiments, the user device 2000 may generate data for updating the copresence estimation model 300. The user device 2000 may generate a training dataset for personalizing the copresence estimation model 300 by using data collected as the user device operates in the user's space. The user device 2000 may fine-tune the base model by using the training dataset. In other words, the user device 2000 may optimize the copresence estimation model 300 to operate properly in the user's space.

The data for updating the copresence estimation model 300 may include feedback data generated based on user feedback, and filtered data obtained by filtering out high-quality data from pre-collected data. Specific operations, performed by the user device 2000, of generating data for updating the copresence estimation model 300 will be described in detail in the description of the drawings described below.

Further, optimization of the copresence estimation model 300 is intended to improve copresence estimation performance in the user's space. Accordingly, the copresence estimation model 300 after update may be referred to as “optimized model,” “personalized model,” “customized model,” “post-fine-tuning model,” “post-update model,” etc., and may also be referred to by various expressions indicating the same or similar concepts as the above-described examples.

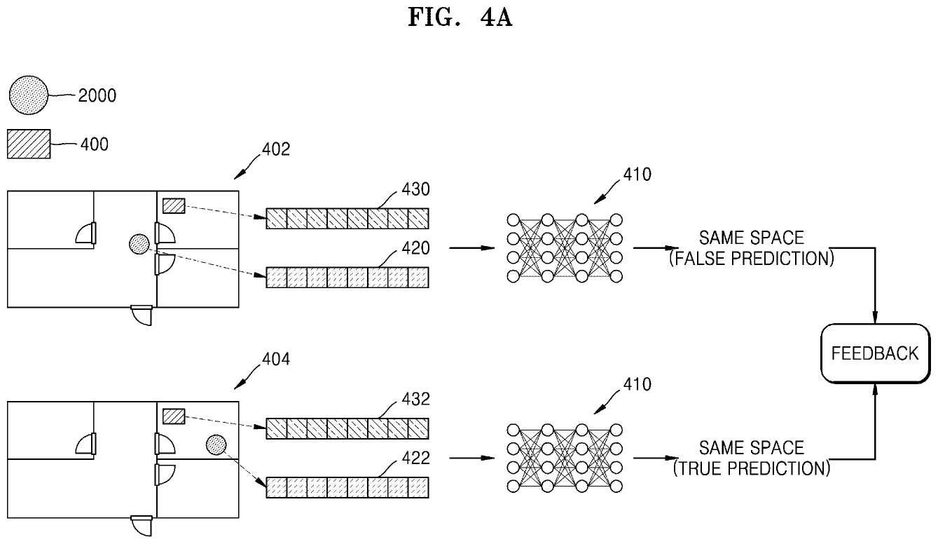

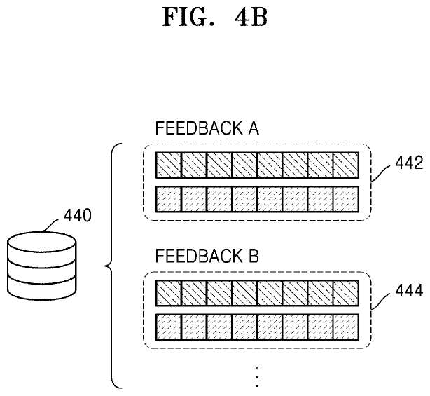

FIG. 4A is a diagram illustrating an operation, performed by a user device, of obtaining feedback on a result of copresence estimation, according to one or more embodiments of the present disclosure.

In one or more embodiments, the user device 2000 may estimate whether each of the plurality of other devices is present in the same space as the user device 2000. FIG. 4B illustrates an example in which, with respect to a device A 400 among the other devices, copresence or non-copresence is estimated and feedback data is generated.

In one or more embodiments, the user device 2000 may perform a copresence estimation task to infer whether the device A 400 is present in the same space as the user device 2000. The copresence estimation task may be initiated based on a user input for executing a copresence estimation function.

The user device 2000 may estimate whether the device A 400 is present in the same space as the user device 2000 by inputting a Wi-Fi RSSI of the user device 2000 and a Wi-Fi RSSI of the device A 400 into a copresence estimation model 410. The user device 2000 may obtain feedback on a result of the estimation. The feedback may include information indicating that the result of the estimation is inaccurate (or information indicating that the result of the estimation is accurate). In addition, the feedback may include location information of the user device 2000 and/or location information of the device A 400.

Referring to a first example 402, the user device 2000 is present in a different space from the device A 400. The user device 2000 may input, into the copresence estimation model 410, a first Wi-Fi RSSI A 420, which is the Wi-Fi RSSI of the user device 2000, and a second Wi-Fi RSSI A 430, which is the Wi-Fi RSSI of the device A 400. At this time, a result of estimation of the copresence estimation model 410 may be output as “same space.” Because the user device 2000 and the device A 400 are present in different spaces, the result of the estimation in the first example 402 is a false prediction.

Referring to a second example 404, the user device 2000 is present in the same space as the device A 400. The user device 2000 may input, into the copresence estimation model 410, a first Wi-Fi RSSI B 422, which is the Wi-Fi RSSI of the user device 2000, and a second Wi-Fi RSSI B 432, which is the Wi-Fi RSSI of the device A 400, and obtain an output of “same space” as a result of estimation. Because the user device 2000 and the device A 400 are present in the same space, the result of the estimation in the second example 404 is a true prediction.

The user device 2000 may obtain feedback on the result of the estimation. The feedback may be obtained in a variety of ways. For example, after the result of the estimation is output, the user device 2000 may receive a user input indicating feedback on the result of the estimation. In addition, for example, the user device 2000 may output the result of the estimation, and output a user interface for requesting feedback on the result of the estimation.

In one or more embodiments, the feedback may include information indicating that the result of the estimation is inaccurate and/or location information of the user device 2000. When the feedback includes information indicating that the result of the estimation is inaccurate, the user device 2000 may, based on the feedback, configure a negative pair including the Wi-Fi RSSI of the user device 2000 and a Wi-Fi RSSI of a device estimated to be present in the same space as the user device 2000, among the plurality of other devices. The term “negative pair” is a label indicating that two devices are present in different spaces. In addition, when the feedback includes location information of the user device 2000, the user device 2000 may, based on the feedback, configure a positively pair including the Wi-Fi RSSI of the user device 2000 and a Wi-Fi RSSI of a device having location information corresponding to the location information of the user device 2000, among the plurality of other devices. The term “positive pair” is a label indicating that two devices are present in the same space. In this case, the user device 2000 may receive, from the plurality of other devices, location information of the plurality of other devices.

Referring again to the first example 402, the result of the estimation in the first example 402 indicates that the device A 400 is present in the same space as the user device 2000. Because this is a false prediction, the feedback may include information indicating that the result of the estimation is inaccurate. In this case, the user device 2000 may configure, based on the feedback, a negative pair including the first Wi-Fi RSSI A 420, which is the Wi-Fi RSSI of the user device 2000, and the second Wi-Fi RSSI A 430, which is the Wi-Fi RSSI of the device A 400 estimated to be present in the same space as the user device 2000. In addition, the user device 2000 may identify a device having location information corresponding to the location information of the user device 2000, among the other devices excluding the device A 400, and generate a positive pair of the first Wi-Fi RSSI and the second Wi-Fi RSSI.

In one or more embodiments, the feedback may include information indicating that the result of the estimation is accurate. When the feedback includes information indicating that the result of the estimation is accurate, the user device 2000 may configure, based on the feedback, a positive pair including the Wi-Fi RSSI of the user device 2000 and the Wi-Fi RSSI of another device. For example, when the feedback on the result of the estimation is received in the second example 404, the user device 2000 may configure a positive pair including the first Wi-Fi RSSI B 422, which is the Wi-Fi RSSI of the user device 2000, and the second Wi-Fi RSSI B 432, which is the Wi-Fi RSSI of the device A 400.

FIG. 4B is a diagram illustrating an operation, performed by a user device, of generating feedback data, according to one or more embodiments of the present disclosure.

In one or more embodiments, the user device 2000 may generate, based on feedback, a feedback dataset 440 including feedback data including a first Wi-Fi RSSI, and a second Wi-Fi RSSI of another device.

In one or more embodiments, a plurality of other devices may be provided. For example, the plurality of other devices may include a device A and a device B. Feedback data A 442 may be obtained based on feedback on a result of estimating copresence or non-copresence between the user device 2000 and the device A. In this case, the feedback data A 442 may include {first Wi-Fi RSSI A, second Wi-Fi RSSI A} of the user device 2000 and the device A, and feedback information. Similarly, feedback B may include {first Wi-Fi RSSI B, second Wi-Fi RSSI B} of the user device 2000 and the device B, and feedback information.

The user device 2000 may generate the feedback dataset 440 in which the first Wi-Fi RSSI and each of the plurality of second Wi-Fi RSSIs are matched in pairs. In this regard, when the user device 2000 estimates copresence or non-copresence between the user device 2000 and each of the plurality of other devices, feedback may be received for only some of results of estimation for the plurality of other devices. In this case, the user device 2000 may include, in the feedback dataset 440, only data corresponding to the feedback. For example, feedback on a result of estimating copresence or non-copresence between the user device 2000 and the device A and a feedback on a result of estimating copresence or non-copresence between the user device 2000 and the device B may be obtained, whereas feedback on a result of estimating copresence or non-copresence between the user device 2000 and a device C may not be obtained. In this case, the feedback dataset 440 may only include the feedback data A 442 and the feedback data B 444, which correspond to devices for which feedback is obtained by the user device 2000.

FIG. 5A is a diagram illustrating data collection operations of a user device and another device, according to one or more embodiments of the present disclosure.

In the description of FIG. 5A and FIG. 5B, it is assumed that a plurality of devices corresponding to a second Wi-Fi RSSI are located in different spaces from each other. FIG. 5A illustrates a specific example in which a device A is in a room A, a device B is in a living room, a device C is in a room B, and a device D is in a room C.

In one or more embodiments, the user device 2000 may continuously collect a first Wi-Fi RSSI corresponding to nearby Wi-Fi networks of the user device 2000. The user device 2000 may store the first Wi-Fi RSSI periodically or aperiodically. The first Wi-Fi RSSI stored through continuous collection may be referred to as a “pre-collected first Wi-Fi RSSI 510.”

In addition, each of the other devices may continuously collect a second Wi-Fi RSSI corresponding to nearby Wi-Fi networks of each device. The second Wi-Fi RSSI stored through continuous collection may be referred to as a “pre-collected second Wi-Fi RSSI 520.” The pre-collected second Wi-Fi RSSI 520 may include second Wi-Fi RSSIs of the plurality of other devices. For example, the pre-collected second Wi-Fi RSSI 520 may include a second Wi-Fi RSSI 522 of the device A, a second Wi-Fi RSSI 524 of the device B, . . . , etc.

In one or more embodiments, the user device 2000 may receive the pre-collected second Wi-Fi RSSI 520 from the other devices. The user device 2000 may generate a raw dataset 530 including pairs of {first Wi-Fi RSSI, second Wi-Fi RSSI} by matching the pre-collected first Wi-Fi RSSI 510 with the pre-collected second Wi-Fi RSSI 520. The user device 2000 may filter out bad data from the raw dataset 530 based on preset conditions and leave only good data. An operation, performed by the user device 2000, of filtering data will be further described with reference to FIG. 5B.

FIG. 5B is a diagram illustrating an operation, performed by a user device, of generating a filtered dataset, according to one or more embodiments of the present disclosure.

In one or more embodiments, the user device 2000 may generate a filtered dataset 540 by filtering the pre-collected first Wi-Fi RSSI 510 and a plurality of pre-collected second Wi-Fi RSSIs 520 according to preset conditions.

The user device 2000 may perform an inference operation of a copresence estimation model by applying the pre-collected first Wi-Fi RSSI 510 and the plurality of pre-collected second Wi-Fi RSSIs 520 as input data to the copresence estimation model. For example, the user device 2000 may estimate whether the device A is present in the same space as the user device 2000 by applying the pre-collected first Wi-Fi RSSI 510 and the pre-collected second Wi-Fi RSSI 522 of the device A to the copresence estimation model. In addition, the user device 2000 may estimate whether the device B is present in the same space as the user device 2000 by using the pre-collected first Wi-Fi RSSI 510 and the pre-collected second Wi-Fi RSSI 524 of the device B, and may estimate whether the device C is present in the same space as the user device 2000 by using the pre-collected first Wi-Fi RSSI 510 and a pre-collected second Wi-Fi RSSI 526 of the device C.

The user device 2000 may filter data based on a result of the estimation of the copresence estimation model. The user device 2000 may determine, based on the number of devices estimated to be present in the same space as the user device 2000, among the plurality of other devices, whether to filter the pre-collected first Wi-Fi RSSI and the plurality of pre-collected second Wi-Fi RSSIs.

In one or more embodiments, the preset conditions for determining whether to filter data after the user device 2000 performs copresence estimation for the plurality of other devices may be as follows.

When the number of devices estimated to be present in the same space as the user device 2000 among the other devices is 1, the user device 2000 may configure a positive pair including the first Wi-Fi RSSI and a second Wi-Fi RSSI of a device estimated to be present in the same space as the user device 2000, configure a negative pair including the first Wi-Fi RSSI and a second Wi-Fi RSSI of the remaining devices, and include the positive and negative pairs in the filtered dataset 540.

When the number of devices estimated to be present in the same space as the user device 2000 among the other devices is 2 or more, the user device 2000 may classify the estimation as a potential false case, and include the first Wi-Fi RSSI and the second Wi-Fi RSSI used for inference in a preliminary dataset 560.

When the number of devices estimated to be present in the same space as the user device 2000 among the other devices is 0, the user device 2000 may filter the first Wi-Fi RSSI and the second Wi-Fi RSSI used for inference.

For example, referring to a first example 552 of the result of the estimation, the result of the estimation indicates that the user device 2000 is present in the same space as the device A and in a different space from the device B and the device C. In this case, because the device A, the device B, and the device C are in different spaces from each other, data of the result of the estimation in the first example 552 is good data that is reliable. For example, the user device 2000 is present in the same space as the device A and in a different space from the device B and the device C, and the inference of the copresence estimation model is accurate. Accordingly, the user device 2000 may configure a positive pair including the first Wi-Fi RSSI and the second Wi-Fi RSSI corresponding to the device A, configure negative pairs including the first Wi-Fi RSSI and the second Wi-Fi RSSI corresponding to the device B, and the first Wi-Fi RSSI and the second Wi-Fi RSSI corresponding to the device C, respectively, and include good data pairs in the filtered dataset 540.

In addition, for example, referring to a second example 554 of the result of the estimation, the result of the estimation indicates that the user device 2000 is present in the same space as the device A and the device B and in a different space from the device C. In this case, because the device A, the device B, and the device C are in different spaces from each other, data of the result of the estimation in the second example 554 includes an error, which indicates a potential error that may occur in the user's actual usage environment. In this case, the user device 2000 may include the first Wi-Fi RSSI and the second Wi-Fi RSSI used for inference in the preliminary dataset 560. In one or more embodiments, as the user device 2000 updates the copresence estimation model, the performance of the copresence estimation model may be improved. Accordingly, at a certain time point after continuous updates, the data included in the preliminary dataset 560 may also become good data that may be used to update the copresence estimation model. After the copresence estimation model is updated, the user device 2000 may re-examine the data in the preliminary dataset 560. The user device 2000 may perform a copresence estimation task by using the data in the preliminary dataset 560. In this case, when the number of devices estimated to be present in the same space as the user device 2000 among the other devices is 1, the user device 2000 may include the first Wi-Fi RSSI and the second Wi-Fi RSSI used for inference in the filtered dataset 540.

In addition, for example, referring to a third example 554 of the result of the estimation, the result of the estimation indicates that the user device 2000 is present in a different space from the device A, the device B, and the device C. For example, when no devices are estimated to be present in the same space as in the third example 554, the user device 2000 does not use the first Wi-Fi RSSI and the second Wi-Fi RSSI used for inference to update the copresence estimation model.

By generating the filtered dataset 540, the user device 2000 may secure a positive pair of the first Wi-Fi RSSI and the second Wi-Fi RSSI that may be used for fine-tuning the copresence estimation model. The user device 2000 may update the copresence estimation model by using the filtered dataset 540, thereby improving the performance of a space estimation model for the user space.

In this regard, although FIG. 5B illustrates an example in which three devices other than the user device 2000 are provided, the number of other devices is not limited thereto. In other words, two or more other devices may be provided. When the number of devices estimated to be present in the same space as the user device among the devices is 1, the user device 2000 may secure a positive pair of the first Wi-Fi RSSI and the second Wi-Fi RSSI.

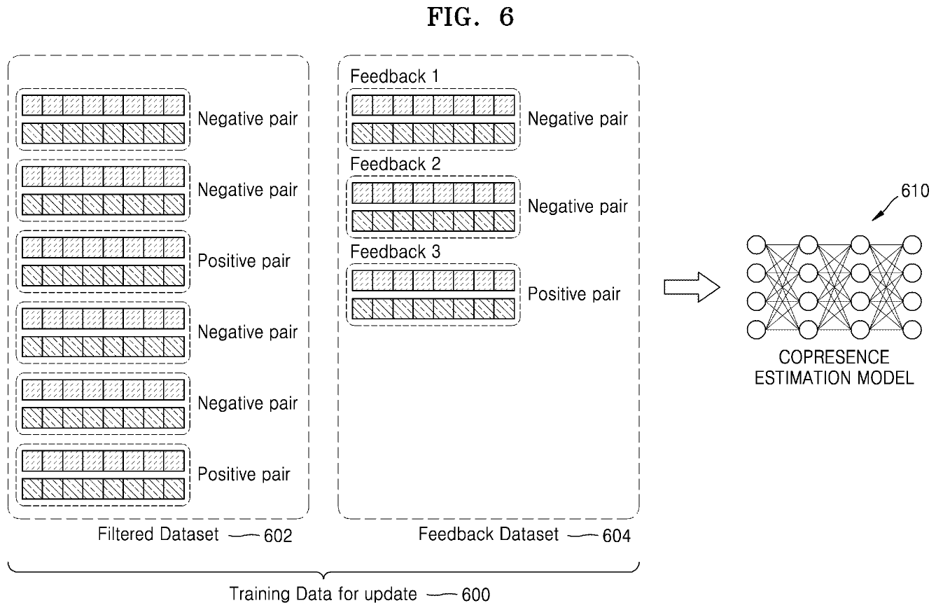

FIG. 6 is a diagram illustrating a training dataset generated by a user device, according to one or more embodiments of the present disclosure.

In one or more embodiments, the user device 2000 may generate a training dataset 600. The user device 2000 may fine-tune a copresence estimation model 610 by using the training dataset 600.

The training dataset 600 may include a filtered dataset 602 and a feedback dataset 604.

The filtered dataset 602 may include {first Wi-Fi RSSI, second Wi-Fi RSSI} data pairs filtered according to preset conditions, among pre-collected Wi-Fi RSSIs. A data pair may be a positive pair indicating the same space, or a negative pair indicating different spaces. An operation, performed by the user device 2000, of generating the filtered dataset 602 has been described above in the description of FIGS. 5A and 5B, and thus, a repeated description thereof will be omitted.

The feedback dataset 604 may include {first Wi-Fi RSSI, second Wi-Fi RSSI} data pairs generated based on feedback. A data pair may be a positive pair indicating the same space, or a negative pair indicating different spaces. An operation, performed by the user device 2000, of generating the feedback dataset 604 has been described above in the description of FIGS. 4A and 4B, and thus, a repeated description thereof will be omitted.

In order for the user device 2000 to fine-tune the copresence estimation model 610, a sufficient amount of data is required in the training dataset 600. However, feedback data, which is high-quality data that may be used for training, is collected as the user device 2000 is used, and thus, the amount of such data is smaller than that of continuously collected data, and collecting a sufficient amount of the data requires a significant amount of time. In addition to the feedback data, the user device 2000 may continuously filter pre-collected data and include the filtered data in the training dataset 600, thereby enabling the feedback data to be quickly reflected in the copresence estimation model 610.

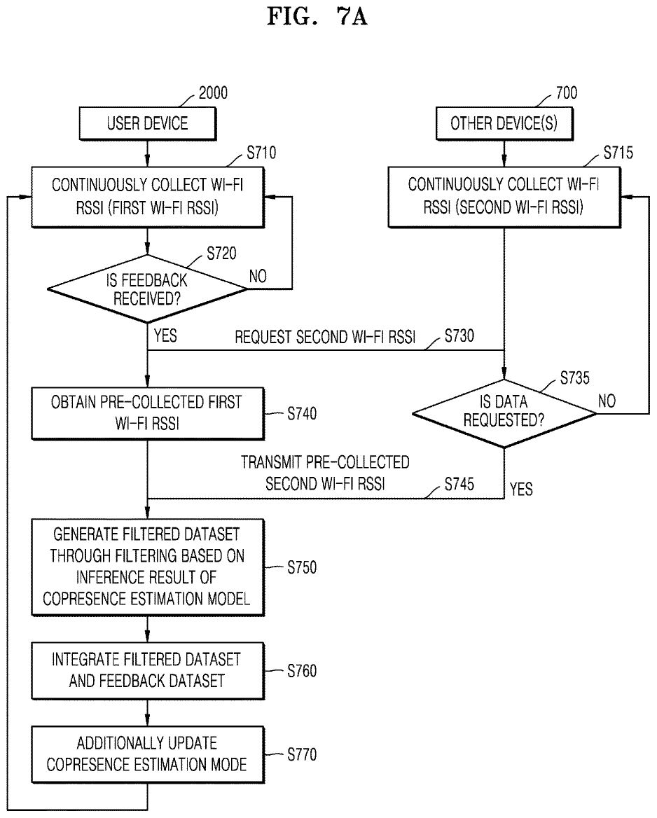

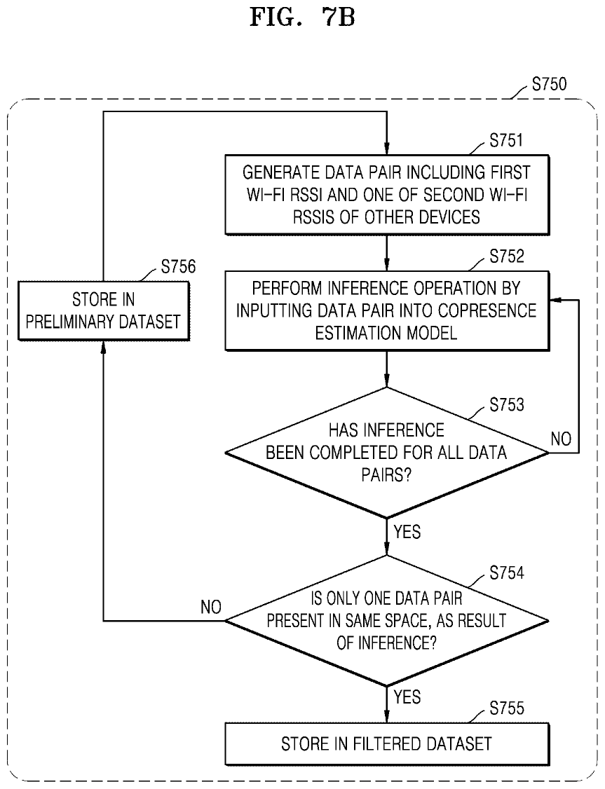

In one or more embodiments, an operation, performed by the user device 2000, of generating the training dataset 600 may be initiated based on feedback being received by the user device 2000. For example, after the user uses the user device 2000 to estimate whether another device is present in the same space as the user device, feedback on a result of the estimation may be received from the user. In this case, in response to receiving the feedback, the user device 2000 may generate the training dataset 600 including the feedback dataset 604 and the filtered dataset 602, and update the copresence estimation model. This aspect will be further described with reference to FIGS. 7A and 7B.

FIG. 7A is a flowchart illustrating an operating method of a user device when receiving feedback, according to one or more embodiments of the present disclosure.

In operation S710, the user device 2000 may continuously collect and store a Wi-Fi RSSI (first Wi-Fi RSSI). The first Wi-Fi RSSI may be collected periodically or aperiodically when the user device 2000 is in a standby state or an active state.

In operation S715, another device 700 may continuously collect and store a Wi-Fi RSSI (second Wi-Fi RSSI). There may be one or more other devices 700. The second Wi-Fi RSSI may be collected periodically or aperiodically when the other device 700 is in a standby state or an active state. When a plurality of other devices 700 are provided, each device may continuously collect a Wi-Fi RSSI. For example, a device A and a device B, which are different from each other, may each continuously collect a second Wi-Fi RSSI representing nearby Wi-Fi networks.

In operation S720, the user device 2000 may identify that feedback is received.

In one or more embodiments, operations S210 to S230 of FIG. 2 may be performed before operation S720 is performed. In other words, the user device 2000 may estimate whether the other device 700 is present in the same space as the user device 2000 by inputting the first Wi-Fi RSSI of the user device 2000 and the second Wi-Fi RSSI of the other device 700 into a copresence estimation model. The user device 2000 may receive a user input for inputting feedback on a result of the estimation. When no feedback is received, the user device 2000 performs operation S710 again. When feedback is received, the user device 2000 may perform operations S730 and S740.

In one or more embodiments, when feedback is received, the user device 2000 may generate a feedback dataset based on the feedback. The feedback dataset may include feedback data including at least one {first Wi-Fi RSSI, second Wi-Fi RSSI}.

In operation S730, based on the feedback being received, the user device 2000 may request the second Wi-Fi RSSI from the other device 700. When a plurality of other devices 700 are provided, the user device 2000 may request the second Wi-Fi RSSI from each of the plurality of other devices 700.

In operation S735, the other device 700 may identify a data request from the user device 2000. When no data request is identified, the other device 700 performs operation S715 again. When a data request is identified, the other device 700 may transmit a pre-collected second Wi-Fi RSSI to the user device 2000 (operation S745). The pre-collected second Wi-Fi RSSI may be collected in operation S715.

In operation S740, the user device 2000 may obtain a pre-collected first Wi-Fi RSSI. The pre-collected first Wi-Fi RSSI may be collected in operation S710.

In operation S750, the user device 2000 may generate a filtered dataset through filtering based on a result of inference of the copresence estimation model. The user device 2000 may generate the filtered dataset by filtering the pre-collected first Wi-Fi RSSI and the pre-collected second Wi-Fi RSSI. Specific operations included in operation S750 will be further described with reference to FIG. 7B.

In operation S760, the user device 2000 may integrate the filtered dataset and the feedback dataset. The user device 2000 may generate a training dataset including the filtered dataset and the feedback dataset.

In operation S770, the user device 2000 may additionally update the copresence estimation model. The user device 2000 may fine-tune the copresence estimation model by using the newly generated training dataset, thereby optimizing the space estimation model to suit the user's space. After updating the copresence estimation model, the user device 2000 may perform operation S710 again to collect a first Wi-Fi RSSI. When feedback is received again thereafter, the user device 2000 may perform operations S720 to S770 to update the copresence estimation model again.

In one or more embodiments, the user device 2000 may repeatedly generate a training dataset and update the copresence estimation model each time feedback is received.

In one or more embodiments, the user device 2000 may repeatedly generate a training dataset and update the copresence estimation model, based on preset conditions. For example, the user device 2000 may update the copresence estimation model whenever feedback is received a preset number N of times. However, the preset conditions are not limited thereto, and various conditions triggered by the reception of feedback may be defined as the preset conditions.

FIG. 7B is a flowchart illustrating an operation of FIG. 7A in more detail.

Operations S751 to S756 of FIG. 7B describe detailed operations of operation S750 of FIG. 7A. Therefore, operations S710 to S740 of FIG. 7A may be performed before operation S751 is performed.

In operation S751, the user device 2000 generates a data pair including the first Wi-Fi RSSI and one of the second Wi-Fi RSSIs of the other devices.

The user device 2000 may obtain a pre-collected first Wi-Fi RSSI and pre-collected second Wi-Fi RSSIs of the other devices, and generate a data pair of the first Wi-Fi RSSI and the second Wi-Fi RSSI. For example, the user device 2000 may generate a data pair {first Wi-Fi RSSI, second Wi-Fi RSSI A} in which the Wi-Fi RSSI of the user device 2000 and the Wi-Fi RSSI of the device A are matched, and generate a data pair {first Wi-Fi RSSI, second Wi-Fi RSSI B} in which the Wi-Fi RSSI of the user device 2000 and the Wi-Fi RSSI of the device B are matched.

In operation S752, the user device 2000 may perform an inference operation by inputting the data pair into the copresence estimation model. For example, the user device 2000 may input the data pair {first Wi-Fi RSSI, second Wi-Fi RSSI A} into the copresence estimation model to perform an inference operation to estimate whether the device A is present in the same space as the user device 2000.

In operation S753, the user device 2000 checks whether inference has been completed for all data pairs. For example, inference may have been performed for the data pair {first Wi-Fi RSSI, second Wi-Fi RSSI A}, but inference may not have been performed for the data pair {first Wi-Fi RSSI, second Wi-Fi RSSI B}. In this case, the user device 2000 may perform operation S752 again to estimate whether the device B is present in the same space as the user device 2000. The user device 2000 may repeat operation S752 until the inference operation is completed for all other devices. When inference is completed for all data pairs and results of copresence estimation for all other devices are obtained, the user device 2000 may perform operation S754.

In operation S754, as a result of inference, the user device 2000 may identify whether only one data pair is present in the same space. When only one data pair is present in the same space, the user device 2000 may perform operation S755 to store the data pairs used for inference in the filtered dataset. For example, as a result of inference, the device A may be estimated to be present in the same space as the user device 2000, and the device B may be estimated to be present in a different space from the user device 2000. In this case, the user device 2000 may include the data pairs used for inference in the filtered dataset. In other cases, the user device 2000 may perform operation S756 to store the data pairs used for inference in a preliminary dataset. For example, both the device A and the device B may be estimated to be present in the same space as the user device 2000. In this case, the user device 2000 may filter the data pairs used for inference and include the filtered data pairs in the preliminary dataset. The data pairs included in the preliminary dataset are not used directly to update the current copresence estimation model, but may be used to update the copresence estimation model in the future. For example, after the copresence estimation model is updated, the user device 2000 may perform a copresence estimation task by using the data pairs included in the preliminary dataset. In this case, when the number of devices estimated to be present in the same space as the user device 2000 is 1, the user device 2000 may include the data pairs used for inference in the filtered dataset.

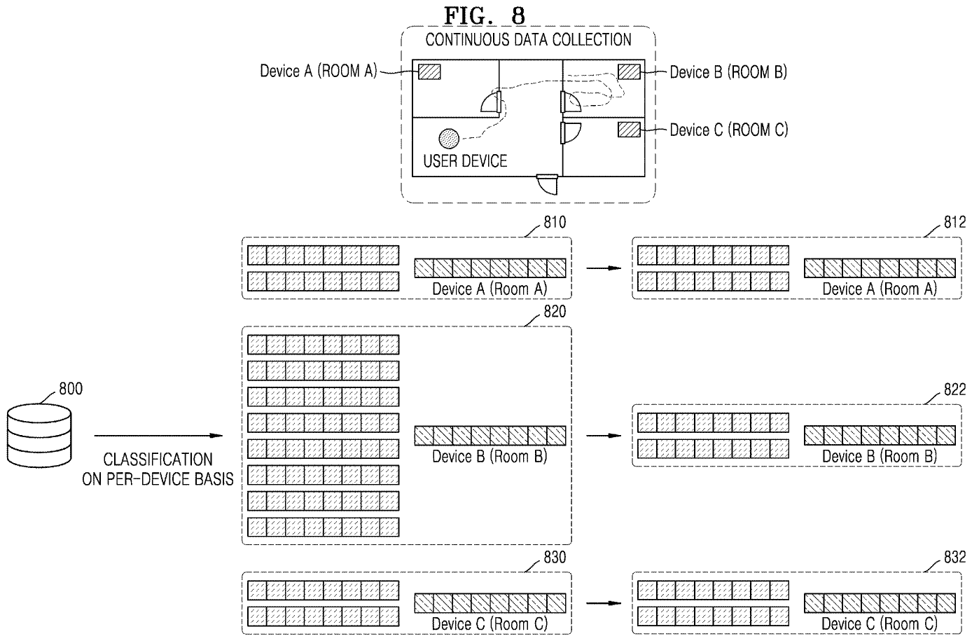

FIG. 8 is a diagram illustrating an operation, performed by a user device, of generating a training dataset, according to one or more embodiments of the present disclosure.

In the description of FIG. 8, an example is described in which a device A is present in a room A, a device B is present in a room C, a device C is present in a room C, and the user device 2000 is a mobile device.

When the user device 2000 is a mobile device, the amount of collected data may vary for each device. For example, when the user device 2000 is present in the room B for a long time, a relatively large number of data pairs of the user device 2000 and the device B may be collected. Accordingly, even in a filtered dataset 800, which is generated by the user device 2000 by filtering a pre-collected first Wi-Fi RSSI of the user device 2000 and a pre-collected second Wi-Fi RSSI according to preset conditions, there may be variations in the amount of data for each device. The user device 2000 may sample data of the filtered dataset 800 to reduce data variation within a training dataset when updating the copresence estimation model.

In one or more embodiments, the user device 2000 may classify, on a per-device basis, a plurality of second Wi-Fi RSSIs are matched with a first Wi-Fi RSSI of the user device. For example, the user device 2000 may classify the data pairs included in the filtered dataset 800 into a dataset 810 of the device A, a dataset 820 of the device B, and a dataset 830 of the device C. As a result of the classification, the dataset 810 of the device A may include data pairs in which the first Wi-Fi RSSI of the user device 2000 and the second Wi-Fi RSSI of the device A are matched, the dataset 820 of the device B may include data pairs in which the first Wi-Fi RSSI of the user device 2000 and the second Wi-Fi RSSI of the device B are matched, and the dataset 830 of the device C may include data pairs in which the first Wi-Fi RSSI of the user device 2000 and the second Wi-Fi RSSI of the device C are matched.

The user device 2000 may sample, based on a classification result, data pairs to be included in the filtered dataset. For example, the user device 2000 may sample data based on a median value of the numbers of data pairs matched on a per-device basis. Specifically, when the dataset 810 of the device A includes two data pairs, the dataset 820 of the device B includes eight data pairs, and the dataset 830 of the device C includes one data pair, the user device 2000 may set the median value, 2, as the sampling number. Accordingly, a sampled dataset 812 of the device A and a sampled dataset 822 of the device B each include two data pairs, and a sampled dataset 832 of the device C includes one data pair. Because the dataset 830 of the device C includes fewer data pairs than the sampling number, all data is used. In this regard, the standard by which the user device 2000 samples data is not limited to the median value of the numbers of data pairs. For example, an average value, a preset value, etc. may be used.

By sampling the data pairs included in the filtered dataset 800, the user device 2000 may reduce the variations in the data included in the filtered dataset 800. The filtered dataset 800 may be integrated with a feedback dataset to generate a training dataset for updating the copresence estimation model.

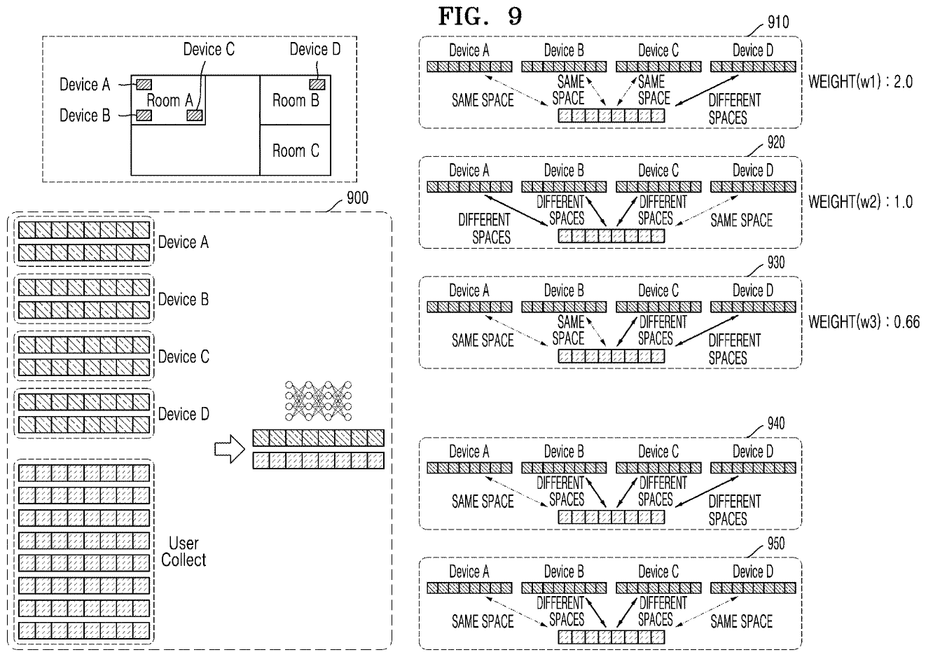

FIG. 9 is a diagram illustrating an operation, performed by a user device, of generating a training dataset, according to one or more embodiments of the present disclosure.

In one or more embodiments, the user device 2000 may generate a filtered dataset by filtering a pre-collected first Wi-Fi RSSI and a plurality of pre-collected second Wi-Fi RSSIs according to preset conditions. In this case, unlike in the example of FIG. 5B, two or more other devices may be present in the same space. For example, FIG. 9 illustrates an example in which a device A, a device B, and a device C are in a room A, a device D is present in a room B, and the user device 2000 is a mobile device.

In one or more embodiments, the user device 2000 may perform an inference operation 900 of a copresence estimation model by applying the pre-collected first Wi-Fi RSSI and the plurality of pre-collected second Wi-Fi RSSIs as input data to the copresence estimation model.

For example, the user device 2000 may estimate whether the device A is present in the same space as the user device 2000 by applying the pre-collected first Wi-Fi RSSI and the pre-collected second Wi-Fi RSSI of the device A to the copresence estimation model. In addition, the user device 2000 may estimate whether the device B, the device C, and the device D are present in the same space as the user device 2000 by using the pre-collected first Wi-Fi RSSI and the pre-collected second Wi-Fi RSSI of each of the device B, the device C, and the device D.

The user device 2000 may filter data based on a result of the estimation of the copresence estimation model. When two or more of the plurality of other devices are present in one space, the user device 2000 may determine whether to filter the pre-collected first Wi-Fi RSSI and the pre-collected second Wi-Fi RSSI, based on information of the plurality of other devices and the number of devices estimated to be present in the same space as the user device 2000.

For example, device information of the plurality of other devices, that is, the device A, the device B, and the device C, may include information indicating that the devices are in the room A.

Referring to a first example 910 of the result of the estimation, the result of the estimation in the first example 910 indicates that the user device 2000 is present in the same space as the device A, the device B, and the device C and in a different space from the device D. In this case, because there is information indicating that the device A, the device B, and the device C are present in the same space as each other, data of the result of the estimation in the first example 910 is good data that is reliable. For example, the user device 2000 is present in the same space as the device A, the device B, and the device C and in a different space from the device D, and the inference of the copresence estimation model is accurate. Accordingly, the user device 2000 may include, in the filtered dataset, the {first Wi-Fi RSSI, second Wi-Fi RSSI} data pairs used for the inference in the first example 910.

Referring to a second example 920 of the result of the estimation, the result of the estimation in the second example 920 indicates that the user device 2000 is present in a different space from the device A, the device B, and the device C and in the same space as the device D. In this case, because there is information indicating that the device A, the device B, and the device C are present in the same space as each other, data of the result of the estimation in the second example 920 is good data that is reliable. For example, the user device 2000 is present in a different space from the device A, the device B, and the device C and in the same space as the device D, and the inference of the copresence estimation model is accurate. Accordingly, the user device 2000 may include, in the filtered dataset, the {first Wi-Fi RSSI, second Wi-Fi RSSI} data pairs used for the inference in the second example 920.

Referring to a third example 930 of the result of the estimation, the result of the estimation in the third example 930 indicates that the user device 2000 is present in the same space as the device A and the device B and in a different space from the device C and the device D. In this case, because there is information indicating that the device A, the device B, and the device C are present in the same space as each other, data of the result of the estimation in the third example 930 is data that accurately estimates more than a majority (2 out of 3). Accordingly, the user device 2000 may include, in the filtered dataset, the {first Wi-Fi RSSI, second Wi-Fi RSSI} data pairs used for the inference in the third example 930.

Referring to a fourth example 940 and a fifth example 950 of the result of the estimation, data of the result of the estimation in the fourth example 940 is data that accurately estimates less than a majority (1 out of 3), and data of the result of the estimation in the fifth example 950 estimates that the device A and the device D, which are present in different spaces, are present in the same space and thus is regarded as unusable data. Therefore, the data pairs used in the inference in the fourth example 940 and the fifth example 950 may not be included in the filtered dataset.

In one or more embodiments, when the number of devices located in the same space among the other devices is 2 or more, the user device 2000 may assign a weight for sampling to a first Wi-Fi RSSI-second Wi-Fi RSSI pair, based on the result of the estimation of the copresence estimation model.

For example, referring to the first example 910 of the result of the estimation, the result of the estimation in the first example 910 is an accurate result of estimation, and there are three positive pairs in which the user device 2000 is inferred to be present in the same space as the device A, the device B, and the device C, respectively. Accordingly, the user device 2000 may assign a first weight (e.g., 2), which is a relatively high weight, to the {first Wi-Fi RSSI, second Wi-Fi RSSI} data pairs used in the inference in the first example 910.

For example, referring to the second example 920 of the result of the estimation, the result of the estimation in the second example 920 is an accurate result of estimation, and there is one positive pair in which the user device 2000 is inferred to be present in the same space as the device D. Accordingly, the user device 2000 may assign a second weight (e.g., 1), which is lower than the first weight, to the {first Wi-Fi RSSI, second Wi-Fi RSSI} data pairs used in the inference in the second example 920.

For example, referring to the third example 930 of the result of the estimation, the result of the estimation in the third example 930 is a result that accurately estimates more than a majority (2 out of 3). In this case, because the result of the estimation is not entirely accurate, the user device 2000 may assign a third weight (e.g., 0.66), which is lower than the first weight and the second weight, to the {first Wi-Fi RSSI, second Wi-Fi RSSI} data pairs used in the inference in the third example 930.

In one or more embodiments, weights may be used when the user device 2000 generates a filtered dataset. For example, the user device 2000 may sample data based on the weights. Specifically, the user device 2000 may sort data pairs in an order of weights and sample N data pairs with a high weight to configure a filtered dataset. Alternatively, the user device 2000 may configure a filtered dataset by sampling data pairs in proportion to weights.

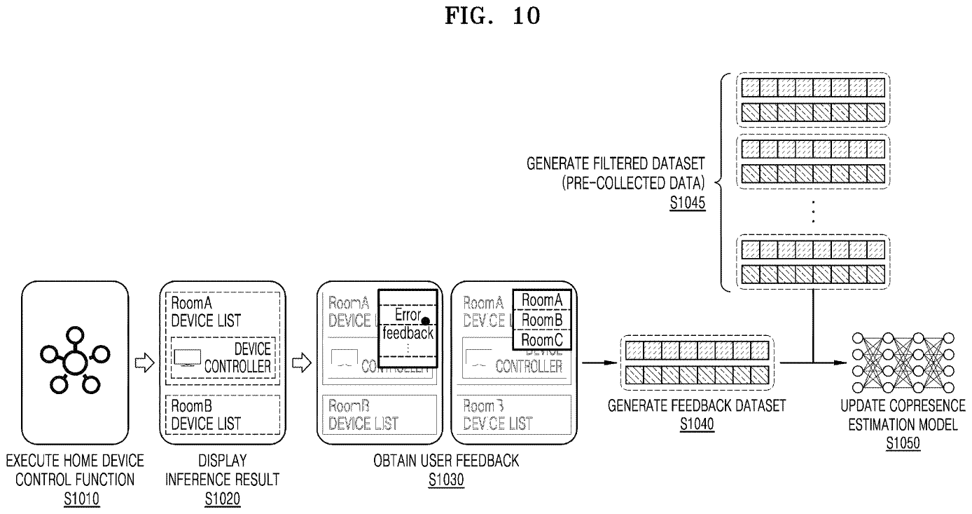

FIG. 10 is a diagram illustrating an operation, performed by a user device, of using a copresence estimation model, according to one or more embodiments of the present disclosure.

In one or more embodiments, the user device 2000 may control a plurality of other devices. For example, the user device 2000 may interact with other devices within the user's home. The other devices within the home and the user device 2000 may be communicatively connected to each other. For example, the user device 2000 and the other devices may be connected to a home network or to a server (e.g., a cloud server).

In operation S1010, the user device 2000 may execute a home device control function. The user device 2000 may receive a user input for executing the home device control function. The home device control function may be provided through an application 1010. For example, a plurality of home devices registered in a smart home application may be controlled through the application.

In operation S1020, the user device 2000 may display a result of inference obtained by using a copresence estimation model. The user device 2000 may estimate a device present in the same space as the current location of the user device 2000, and display a result of the estimation on the screen. For example, the user device 2000 may display a device identified as being present in the same space as the user device 2000, and information of the device. For example, when a device identified as being present in the same space as the user is a device A, and information of the device A is registered as indicating that the device is present in a room A, the user device 2000 may display, on the screen, the device inferred to be present in the same space as the user. Based on a user input for selecting another device displayed on the screen, the user device 2000 may control an operation of the other device. For example, when the other device is a TV, operations such as turning the TV on/off, changing channels, adjusting the volume, and running applications may be performed through the user device 2000.

In operation S1030, the user device 2000 may obtain user feedback. In one or more embodiments, the result of the inference obtained by using the copresence estimation model in operation S1020 may not be accurate. In this case, the user may input feedback into the user device 2000. For example, the user device 2000 may provide a user interface that may evaluate the accuracy/inaccuracy of the result of the inference. The user device 2000 may store feedback information based on a user input. In one or more embodiments, the user device 2000 may receive, from the user, a user input for inputting location information of a device.

In operation S1040, the user device 2000 may generate a feedback dataset. An operation, performed by the user device 2000, of generating a feedback dataset has been described above in the description of the previous drawings, and thus, a repeated description thereof will be omitted for brevity.

In operation S1045, the user device 2000 may generate a filtered dataset. The filtered dataset may be generated by filtering pre-collected Wi-Fi RSSI data. An operation, performed by the user device 2000, of generating a filtered dataset has been described above in the description of the previous drawings, and thus, a repeated description thereof will be omitted for brevity.

In operation S1050, the user device 2000 may update the copresence estimation model. The user device 2000 may fine-tune the copresence estimation model by using a training dataset including the feedback dataset and the filtered dataset. An operation, performed by the user device 2000, of updating a copresence estimation model has been described above in the description of the previous drawings, and thus, a repeated description thereof will be omitted for brevity.

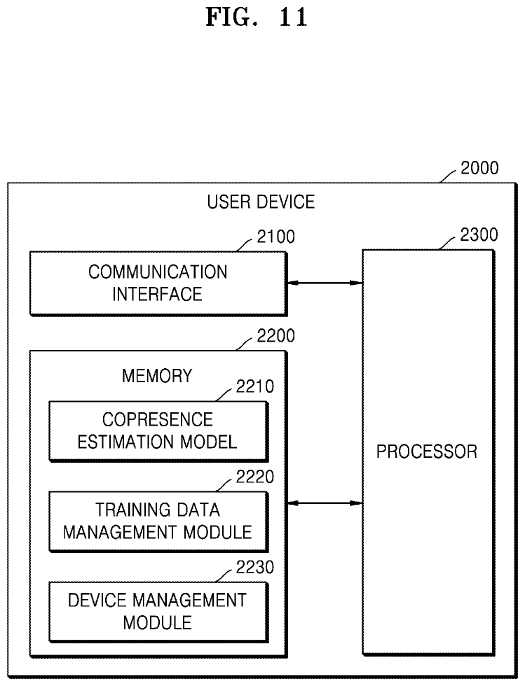

FIG. 11 is a block diagram illustrating a configuration of a user device according to one or more embodiments of the present disclosure.

In one or more embodiments, the user device 2000 may include a communication interface 2100, memory 2200, and a processor 2300.

The communication interface 2100 may include communication circuitry. The communication interface 2100 may use at least one of data communication methods including, for example, wired LAN, wireless LAN, Wi-Fi, Bluetooth, ZigBee, Wi-Fi Direct (WFD), Infrared Data Association (IrDA), Bluetooth Low Energy (BLE), Near Field Communication (NFC), Wireless Broadband Internet (WiBro), World Interoperability for Microwave Access (WiMAX), Shared Wireless Access Protocol (SWAP), Wireless Gigabit Alliances (WiGig), and RF communication. The communication interface 2100 may be implemented to include a plurality of modules (e.g., a Wi-Fi module, etc.) for implementing the above-described communication methods.

The communication interface 2100 may transmit and receive, to and from other devices, data for performing an operation of the user device 2000. For example, the user device 2000 may transmit and receive, to and from the other devices through the communication interface 2100, various data (device information and Wi-Fi RSSI information) used by the user device 2000 to interact with the other devices.

The memory 2200 may store instructions, data structures, and program code that are readable by the processor 2300. There may be one or more memories 2200. In the disclosed embodiments, operations performed by the processor 2300 may be implemented by executing instructions or code of a program stored in the memory 2200.

The memory 2200 may include non-volatile memory such as read-only memory (ROM) (e.g., programmable read-only memory (PROM), erasable programmable read-only memory (EPROM), or electrically erasable programmable read-only memory (EEPROM)), flash memory (e.g., a memory card or a solid-state drive (SSD)), and analog recording type (e.g., a hard disk drive (HDD), a magnetic tape, or an optical disk), and volatile memory such as random-access memory (RAM) (e.g., dynamic random-access memory (DRAM) or static random-access memory (SRAM)).

The memory may store data, instructions, and programs that enable the user device 2000 to operate. For example, the memory 2200 may store a copresence estimation module 2210, a training data management module 2220, and a device management module 2230.

The processor 2300 may control overall operations of the user device 2000. For example, the processor 2300 may control the overall operations of the user device 2000 by executing one or more instructions of a program stored in the memory 2200. There may be one or more processors 2300.

The processor 2300 can estimate whether the user device 2000 and another device are present in the same space by executing the copresence estimation module 2210. The copresence estimation module 2210 may include a copresence estimation model, and data and code for operating the copresence estimation model. Operations, performed by the user device 2000, of using a copresence estimation model have been described above, and thus, a repeated description thereof will be omitted for brevity.

The processor 2300 may generate a training dataset by executing the training data management module 2220. The training data management module may collect a Wi-Fi RSSI of the user device 2000 and Wi-Fi RSSIs of the other devices. The training data management module 2220 may generate a feedback dataset based on feedback received from the user. In addition, the training data management module 2220 may continuously filter pre-collected data to generate a filtered dataset. When the filtered dataset is generated, the copresence estimation module 2210 may be used to obtain inference data of the pre-collected data. Operations, performed by the user device 2000, of generating training data have been described above, and thus, a repeated description thereof will be omitted for brevity.

The processor 2300 may manage a plurality of devices by executing the device management module 2230. The device management module 2230 may transmit and receive data for interacting with the devices. The device management module 2230 may transmit, to another device, a user input input into the user device 2000, transmit, to the other device, a control command for controlling the other device, and receive device information from the other device. Operations, performed by the user device 2000, of interacting with the other devices have been described above, and thus, a repeated description thereof will be omitted for brevity.

In this regard, the modules stored in the memory 2200 described above are provided for convenience of description, and the present disclosure is not necessarily limited thereto. Other modules may be added to implement the above-described embodiments, some of the above-described modules may be implemented as a single module, or any one model of the above-described modules may be implemented by being separated into a plurality of modules.

In one embodiment, the one or more processors 2300 may include at least one of a central processing unit (CPU), a graphics processing unit (GPU), an accelerated processing unit (APU), a Many Integrated Core (MIC), a digital signal processor (DSP), and a neural processing unit (NPU). The one or more processors 2300 may be implemented in the form of an integrated system-on-chip (SoC) including one or more electronic components. Each of the one or more processors 2300 may be implemented as separate hardware (H/W).

When a method according to one or more embodiments of the present disclosure includes a plurality of operations, the plurality of operations may be performed by one processor 2300 or by a plurality of processors 2300. For example, when a first operation, a second operation, and a third operation are performed by the method according to one or more embodiments, the first operation, the second operation, and the third operation may all be performed by a first processor, or the first operation and the second operation may be performed by the first processor (e.g., a general-purpose processor) and the third operation may be performed by a second processor (e.g., an artificial intelligence-dedicated processor). Here, an example of the second processor may be an artificial intelligence-dedicated processor, and the artificial intelligence-dedicated processor may perform operations for training/inference of an artificial intelligence model. However, embodiments of the present disclosure are not limited thereto.

The one or more processors 2300 according to the present disclosure may be implemented as a single-core processor or as a multi-core processor.

When a method according to one or more embodiments of the present disclosure includes a plurality of operations, the plurality of operations may be performed by one core or by a plurality of cores included in the one or more processors 2300.

Further, the user device 2000 may further include additional components to perform operations of one or more embodiments of the present disclosure. For example, the user device 2000 may further include a display, a camera, a microphone, an input/output interface, etc.

One or more embodiments of the present disclosure may provide a user device and an operating method thereof, wherein, in an environment where the user device interacts with a plurality of other devices, the user device may estimate whether the user device is present in the same space as the other devices. In addition, One or more embodiments of the present disclosure may provide a method of generating a training dataset for personalizing a copresence estimation model and using the training dataset to ensure that the copresence estimation model performs properly in a user's environment. The technical problems to be achieved by the present disclosure are not limited to those described above, and other technical problems not mentioned herein will be clearly understood by one of ordinary skill in the art from the description of the present specification.

One or more embodiments of the present disclosure may provide an operating method of a user device. The method may include obtaining a first Wi-Fi RSSI corresponding to nearby Wi-Fi networks of the user device.

The method may include obtaining a plurality of second Wi-Fi RSSIs corresponding to nearby Wi-Fi networks of each of other devices.

The method may include estimating whether the other devices are present in a same space as the user device by applying the first Wi-Fi RSSI and the plurality of second Wi-Fi RSSIs as input data to a copresence estimation model.

The method may include receiving feedback on a result of the estimation. The method may include generating, based on the feedback, a feedback dataset including the first Wi-Fi RSSI and the plurality of second Wi-Fi RSSIs.

The method may include obtaining a pre-collected first Wi-Fi RSSI and a plurality of pre-collected second Wi-Fi RSSIs.

The method may include generating a filtered dataset by filtering the pre-collected first Wi-Fi RSSI and the plurality of pre-collected second Wi-Fi RSSIs according to preset conditions.

The method may include updating the copresence estimation model by using the feedback dataset and the filtered dataset.

The feedback may include location information of the user device and information indicating that the result of the estimation is inaccurate.

The generating of the feedback dataset may include based on the feedback, configuring a negative pair including the first Wi-Fi RSSI and a second Wi-Fi RSSI of a device estimated to be present in the same space as the user device, among the other devices.

The generating of the feedback dataset may include, based on the feedback, configuring a positive pair including the first Wi-Fi RSSI and a second Wi-Fi RSSI of a device having location information corresponding to the location information of the user device, among the other devices.

The generating of the filtered dataset may include applying the pre-collected first Wi-Fi RSSI and the plurality of pre-collected second Wi-Fi RSSIs as input data to the copresence estimation model.

The generating of the filtered dataset may include determining, based on a number of devices estimated to be present in the same space as the user device, among the other devices, whether to filter the pre-collected first Wi-Fi RSSI and the plurality of pre-collected second Wi-Fi RSSIs.

The generating of the filtered dataset may include, when the number of devices estimated to be present in the same space as the user device among the other devices is 1, configuring a positive pair including the first Wi-Fi RSSI and a second Wi-Fi RSSI of a device estimated to be present in the same space as the user device, and configuring a negative pair including the first Wi-Fi RSSI and a second Wi-Fi RSSI of remaining devices.

The generating of the filtered dataset may include classifying, on a per-device basis, the plurality of pre-collected second Wi-Fi RSSIs of the other devices that are matched with the pre-collected first Wi-Fi RSSI of the user device.

The generating of the filtered dataset may include, sampling, based on a result of the classification, a first Wi-Fi RSSI-second Wi-Fi RSSI pair to be included in the filtered dataset.

The generating of the filtered dataset may include, when the number of devices located in the same space among the other devices is 2 or more, assigning a weight for sampling to the first Wi-Fi RSSI-second Wi-Fi RSSI, based on the result of the estimation of the copresence estimation model.

The updating of the copresence estimation model may include assigning a higher weight to the feedback dataset than to the filtered dataset.

The updating of the copresence estimation model may include updating the copresence estimation model by using the weight.

According to an aspect of the present disclosure, a user device may be provided. The user device may include: a communication interface; memory storing one or more instructions; and one or more processors configured to execute the one or more instructions stored in the memory.

The one or more processors may execute the one or more instructions to obtain a first Wi-Fi RSSI corresponding to nearby Wi-Fi networks of the user device.

The one or more processors may execute the one or more instructions to obtain a plurality of second Wi-Fi RSSIs corresponding to nearby Wi-Fi networks of each of other devices.

The one or more processors may execute the one or more instructions to estimate whether the other devices are present in a same space as the user device by applying the first Wi-Fi RSSI and the plurality of second Wi-Fi RSSIs as input data to a copresence estimation model.

The one or more processors may execute the one or more instructions to receive feedback on a result of the estimation.

The one or more processors may execute the one or more instructions to generate, based on the feedback, a feedback dataset including the first Wi-Fi RSSI and the plurality of second Wi-Fi RSSIs.

The one or more processors may execute the one or more instructions to obtain a pre-collected first Wi-Fi RSSI and a plurality of pre-collected second Wi-Fi RSSIs.

The one or more processors may execute the one or more instructions to generate a filtered dataset by filtering the pre-collected first Wi-Fi RSSI and the plurality of pre-collected second Wi-Fi RSSIs according to preset conditions.

The one or more processors may execute the one or more instructions to update the copresence estimation model by using the feedback dataset and the filtered dataset.

The feedback may include location information of the user device and information indicating that the result of the estimation is inaccurate.

The one or more processors may execute the one or more instructions to, based on the feedback, configure a negative pair including the first Wi-Fi RSSI and a second Wi-Fi RSSI of a device estimated to be present in the same space as the user device, among the other devices.

The one or more processors may execute the one or more instructions to, based on the feedback, configure a positive pair including the first Wi-Fi RSSI and a second Wi-Fi RSSI of a device having location information corresponding to the location information of the user device, among the other devices.

The one or more processors may execute the one or more instructions to apply the pre-collected first Wi-Fi RSSI and the plurality of pre-collected second Wi-Fi RSSIs as input data to the copresence estimation model.

The one or more processors may execute the one or more instructions to determine, based on a number of devices estimated to be present in the same space as the user device, among the other devices, whether to filter the pre-collected first Wi-Fi RSSI and the plurality of pre-collected second Wi-Fi RSSIs.

The one or more processors may execute the one or more instructions to, when the number of devices estimated to be present in the same space as the user device among the other devices is 1, configure a positive pair including the first Wi-Fi RSSI and a second Wi-Fi RSSI of a device estimated to be present in the same space as the user device, and configure a negative pair including the first Wi-Fi RSSI and a second Wi-Fi RSSI of remaining devices.

The one or more processors may execute the one or more instructions to classify, on a per-device basis, the plurality of pre-collected second Wi-Fi RSSIs of the other devices that are matched with the pre-collected first Wi-Fi RSSI of the user device.

The one or more processors may execute the one or more instructions to sample, based on a result of the classification, a first Wi-Fi RSSI-second Wi-Fi RSSI pair to be included in the filtered dataset.

The one or more processors may execute the one or more instructions to, when the number of devices located in the same space among the other devices is 2 or more, assign a weight for sampling to the first Wi-Fi RSSI-second Wi-Fi RSSI, based on the result of the estimation of the copresence estimation model.

The one or more processors may execute the one or more instructions to assign a higher weight to the feedback dataset than to the filtered dataset.

The one or more processors may execute the one or more instructions to update the copresence estimation model by using the weight.

Further, one or more embodiments of the present disclosure may be implemented in the form of a recording medium including computer-executable instructions, such as a program module executed by a computer. A computer-readable medium may be any available medium accessible by a computer, and includes both volatile and nonvolatile media, and both removable and non-removable media. In addition, the computer-readable medium may include a computer storage medium and a communication medium. The computer storage medium may include both volatile and non-volatile media, removable and non-removable media implemented in any method or technology for storage of information such as computer-readable instructions, data structures, program modules, or other data. The communication medium may include other data of a modulated data signal, such as computer-readable instructions, data structures, or program modules.

In addition, the computer-readable storage medium may be provided in the form of a non-transitory storage medium. Here, the “non-transitory storage medium” may refer to a tangible device and does not include a signal (e.g., an electromagnetic wave), and this term does not distinguish between a case where data is stored in the storage medium semi-permanently and a case where data is stored in the storage medium temporarily. For example, the “non-transitory storage medium” may include a buffer in which data is temporarily stored.

According to one or more embodiments of the present disclosure, a method according to various embodiments disclosed herein may be provided by being included in a computer program product. The computer program product may be traded as a commercial product between a seller and a buyer. The computer program product may be distributed in the form of a machine-readable storage medium (e.g., compact disc read only memory (CD-ROM)), or may be distributed online (e.g., downloaded or uploaded) through an application store or directly between two user devices (e.g., smartphones). In the case of online distribution, at least a part of the computer program product (e.g., a downloadable application) may be at least temporarily generated or temporarily stored in a machine-readable storage medium, such as a server of a manufacturer, a server of an application store, or a memory of a relay server.

One or more embodiments of the present disclosure may provide a method, wherein the feedback includes: location information corresponding to the user device; and information indicating that the estimation result is inaccurate.

One or more embodiments of the present disclosure may provide a method, wherein the generating the feedback dataset includes: configuring, based on the feedback, a negative pair that includes: the first Wi-Fi RSSI; and a second Wi-Fi RSSI of the plurality of second Wi-Fi RSSIs, the second Wi-Fi RSSI corresponding to a device of the one or more other devices that the estimation result indicates is not present in the same space as the user device.

One or more embodiments of the present disclosure may provide a method, wherein the generating the feedback dataset includes: configuring, based on the feedback, a positive pair that includes: the first Wi-Fi RSSI; and a second Wi-Fi RSSI of the plurality of second Wi-Fi RSSIs, the second Wi-Fi RSSI corresponding to a device of the one or more other devices having location information corresponding to the same space as the location information of the user device.

One or more embodiments of the present disclosure may provide a method, wherein the generating the filtered dataset includes: applying the pre-collected first Wi-Fi RSSI and the plurality of pre-collected second Wi-Fi RSSIs as input data to the copresence estimation model; and determining, based on a number of the one or more other devices that the estimation result indicates are present in the same space as the user device, whether to filter the pre-collected first Wi-Fi RSSI and/or the plurality of pre-collected second Wi-Fi RSSIs.

One or more embodiments of the present disclosure may provide a method, wherein the generating the filtered dataset further includes, when the estimation result indicates that the number of the one or more other devices present in the same space as the user device is 1: configuring a positive pair that includes: the first Wi-Fi RSSI; and a second Wi-Fi RSSI of the plurality of second Wi-Fi RSSIs, the second Wi-Fi RSSI corresponding to a device of the one or more other devices that the estimation result indicates is present in the same space as the user device; and configuring, for all other devices of the one or more other devices, a negative pair that includes: the first Wi-Fi RSSI; and another second Wi-Fi RSSI of the plurality of second Wi-Fi RSSIs.

One or more embodiments of the present disclosure may provide a method, wherein the generating the filtered dataset further includes: classifying each of the one or more other devices based on a corresponding pre-collected second WI-FI RSSI of the plurality of pre-collected second Wi-Fi RSSIs to generate a classification result, the classification result indicating which of the one or more other devices are matched with the pre-collected first Wi-Fi RSSI of the user device; and sampling, based on the classification result, a first Wi-Fi RSSI-second Wi-Fi RSSI pair to be included in the filtered dataset.

One or more embodiments of the present disclosure may provide a user device, wherein the feedback includes: location information corresponding to the user device; and information indicating that the estimation result is inaccurate.

One or more embodiments of the present disclosure may provide a user device, wherein the one or more processors are further configured to execute the one or more instructions to: configure, based on the feedback, a negative pair that includes: the first Wi-Fi RSSI; and a second Wi-Fi RSSI of the plurality of second Wi-Fi RSSIs, the second Wi-Fi RSSI corresponding to a device of the one or more other devices that the estimation result indicates is not present in the same space as the user device.

One or more embodiments of the present disclosure may provide a user device, wherein the one or more processors are further configured to execute the one or more instructions to: configure, based on the feedback, a positive pair that includes: the first Wi-Fi RSSI; and a second Wi-Fi RSSI of the plurality of second Wi-Fi RSSIs, the second Wi-Fi RSSI corresponding to a device of the one or more other devices having location information corresponding to the same space as the location information of the user device.

One or more embodiments of the present disclosure may provide a user device, wherein the one or more processors are further configured to execute the one or more instructions to: apply the pre-collected first Wi-Fi RSSI and the plurality of pre-collected second Wi-Fi RSSIs as input data to the copresence estimation model, and determine, based on a number of the one or more other devices that the estimation result indicates is present in the same space as the user device, whether to filter the pre-collected first Wi-Fi RSSI and/or the plurality of pre-collected second Wi-Fi RSSIs.

One or more embodiments of the present disclosure may provide a user device, wherein the one or more processors are further configured to execute the one or more instructions to: when the estimation result indicates that the number of the one or more other devices present in the same space as the user device is 1: configure a positive pair that includes: the first Wi-Fi RSSI; and a second Wi-Fi RSSI of the plurality of second Wi-Fi RSSIs, the second Wi-Fi RSSI corresponding to a device of the one or more other devices that the estimation result indicates is present in the same space as the user device; and configure, for all other devices of the one or more other devices, a negative pair that includes: the first Wi-Fi RSSI; and another second Wi-Fi RSSI of the plurality of second Wi-Fi RSSIs.

One or more embodiments of the present disclosure may provide a user device, wherein the one or more processors are further configured to execute the one or more instructions to: classify each of the one or more other devices based on a corresponding pre-collected second WI-FI RSSI of the plurality of pre-collected second Wi-Fi RSSIs to generate a classification result, the classification result indicating which of the one or more other devices are matched with the pre-collected first Wi-Fi RSSI of the user device, and sample, based on the classification result, a first Wi-Fi RSSI-second Wi-Fi RSSI pair to be included in the filtered dataset.

One or more embodiments of the present disclosure may provide a non-transitory computer-readable recording medium having recorded thereon a program for executing, on a computer, the disclosed method of operating a user device.

The foregoing description of the present disclosure is provided for illustration, and it will be understood by one of ordinary skill in the art that various changes in form and details may be readily made therein without departing from the technical spirit or essential features of the present disclosure. Therefore, it should be understood that the embodiments described above are illustrative in all respects and not restrictive. For example, each element described to be of a single type may be implemented in a distributed manner and, likewise, elements described as being distributed may be implemented in a combined manner.

The scope of the present disclosure is defined by the appended claims rather than the foregoing detailed description, and all changes or modifications within the scope of the claims and their equivalents should be construed as being included in the scope of the present disclosure.

What is claimed is:

1. An method of operating a user device, the method comprising:
obtaining a first Wi-Fi Received Signal Strength Indicator (RSSI) corresponding to one or more Wi-Fi networks that are in position to communicably connect with the user device;
obtaining a plurality of second Wi-Fi RSSIs corresponding to one or more Wi-Fi networks that are in position to communicably connect with one or more other devices;
estimating, by applying the first Wi-Fi RSSI and the plurality of second Wi-Fi RSSIs as input data to a copresence estimation model, an estimation result that indicates whether the one or more other devices are present in a same space as the user device;
receiving feedback based on the estimation result;
generating, based on the feedback, a feedback dataset comprising the first Wi-Fi RSSI and the plurality of second Wi-Fi RSSIs;
obtaining a pre-collected first Wi-Fi RSSI corresponding to the one or more Wi-Fi networks that are in position to communicably connect with the user device;
obtaining a plurality of pre-collected second Wi-Fi RSSIs corresponding to the one or more Wi-Fi networks that are in position to communicably connect with the one or more other devices;
generating, by filtering the pre-collected first Wi-Fi RSSI and the plurality of pre-collected second Wi-Fi RSSIs according to preset conditions, a filtered dataset; and
updating, based on the feedback dataset and the filtered dataset, the copresence estimation model.

2. The method of claim 1, wherein the feedback comprises:
location information corresponding to the user device; and
information indicating that the estimation result is inaccurate.

3. The method of claim 2, wherein the generating the feedback dataset comprises:
configuring, based on the feedback, a negative pair that comprises:
the first Wi-Fi RSSI; and
a second Wi-Fi RSSI of the plurality of second Wi-Fi RSSIs, the second Wi-Fi RSSI corresponding to a device of the one or more other devices that the estimation result indicates is not present in the same space as the user device.

4. The method of claim 2, wherein the generating the feedback dataset comprises:
configuring, based on the feedback, a positive pair that comprises:
the first Wi-Fi RSSI; and
a second Wi-Fi RSSI of the plurality of second Wi-Fi RSSIs, the second Wi-Fi RSSI corresponding to a device of the one or more other devices having location information corresponding to the same space as the location information of the user device.

5. The method of claim 1, wherein the generating the filtered dataset comprises:
applying the pre-collected first Wi-Fi RSSI and the plurality of pre-collected second Wi-Fi RSSIs as input data to the copresence estimation model; and
determining, based on a number of the one or more other devices that the estimation result indicates are present in the same space as the user device, whether to filter the pre-collected first Wi-Fi RSSI and/or the plurality of pre-collected second Wi-Fi RSSIs.

6. The method of claim 5, wherein the generating the filtered dataset further comprises, when the estimation result indicates that the number of the one or more other devices present in the same space as the user device is 1:
configuring a positive pair that comprises:
the first Wi-Fi RSSI; and
a second Wi-Fi RSSI of the plurality of second Wi-Fi RSSIs, the second Wi-Fi RSSI corresponding to a device of the one or more other devices that the estimation result indicates is present in the same space as the user device; and
configuring, for all other devices of the one or more other devices, a negative pair that comprises:
the first Wi-Fi RSSI; and
another second Wi-Fi RSSI of the plurality of second Wi-Fi RSSIs.

7. The method of claim 5, wherein the generating the filtered dataset further comprises:
classifying each of the one or more other devices based on a corresponding pre-collected second WI-FI RSSI of the plurality of pre-collected second Wi-Fi RSSIs to generate a classification result, the classification result indicating which of the one or more other devices are matched with the pre-collected first Wi-Fi RSSI of the user device; and
sampling, based on the classification result, a first Wi-Fi RSSI-second Wi-Fi RSSI pair to be included in the filtered dataset.

8. A user device comprising:
a communication interface;
memory storing one or more instructions; and
one or more processors configured to execute, individually or collectively, the one or more instructions stored in the memory,
wherein the one or more processors are configured to execute the one or more instructions to:
obtain a first Wi-Fi Received Signal Strength Indicator (RSSI) corresponding to one or more Wi-Fi networks that are in position to communicably connect with the user device,
obtain a plurality of second Wi-Fi RSSIs corresponding to one or more Wi-Fi networks that are in position to communicably connect with one or more other devices,
estimate, by applying the first Wi-Fi RSSI and the plurality of second Wi-Fi RSSIs as input data to a copresence estimation model, an estimation result that indicates whether the one or more other devices are present in a same space as the user device,
receive feedback based on the estimation result,
generate, based on the feedback, a feedback dataset comprising the first Wi-Fi RSSI and the plurality of second Wi-Fi RSSIs,
obtain a pre-collected first Wi-Fi RSSI corresponding to the one or more Wi-Fi networks that are in position to communicably connect with the user device;
obtain a plurality of pre-collected second Wi-Fi RSSIs corresponding to the one or more Wi-Fi networks that are in position to communicably connect with the one or more other devices,
generate, by filtering the pre-collected first Wi-Fi RSSI and the plurality of pre-collected second Wi-Fi RSSIs according to preset conditions, a filtered dataset, and
update, based on the feedback dataset and the filtered dataset, the copresence estimation model.

9. The user device of claim 8, wherein the feedback comprises:
location information corresponding to the user device; and
information indicating that the estimation result is inaccurate.

10. The user device of claim 9, wherein the one or more processors are further configured to execute the one or more instructions to:
configure, based on the feedback, a negative pair that comprises:
the first Wi-Fi RSSI; and
a second Wi-Fi RSSI of the plurality of second Wi-Fi RSSIs, the second Wi-Fi RSSI corresponding to a device of the one or more other devices that the estimation result indicates is not present in the same space as the user device.

11. The user device of claim 9, wherein the one or more processors are further configured to execute the one or more instructions to:
configure, based on the feedback, a positive pair that comprises:
the first Wi-Fi RSSI; and
a second Wi-Fi RSSI of the plurality of second Wi-Fi RSSIs, the second Wi-Fi RSSI corresponding to a device of the one or more other devices having location information corresponding to the same space as the location information of the user device.

12. The user device of claim 8, wherein the one or more processors are further configured to execute the one or more instructions to:
apply the pre-collected first Wi-Fi RSSI and the plurality of pre-collected second Wi-Fi RSSIs as input data to the copresence estimation model, and
determine, based on a number of the one or more other devices that the estimation result indicates is present in the same space as the user device, whether to filter the pre-collected first Wi-Fi RSSI and/or the plurality of pre-collected second Wi-Fi RSSIs.

13. The user device of claim 12, wherein the one or more processors are further configured to execute the one or more instructions to:
when the estimation result indicates that the number of the one or more other devices present in the same space as the user device is 1:
configure a positive pair that comprises:
the first Wi-Fi RSSI; and
a second Wi-Fi RSSI of the plurality of second Wi-Fi RSSIs, the second Wi-Fi RSSI corresponding to a device of the one or more other devices that the estimation result indicates is present in the same space as the user device; and
configure, for all other devices of the one or more other devices, a negative pair that comprises:
the first Wi-Fi RSSI; and
another second Wi-Fi RSSI of the plurality of second Wi-Fi RSSIs.

14. The user device of claim 12, wherein the one or more processors are further configured to execute the one or more instructions to:
classify each of the one or more other devices based on a corresponding pre-collected second WI-FI RSSI of the plurality of pre-collected second Wi-Fi RSSIs to generate a classification result, the classification result indicating which of the one or more other devices are matched with the pre-collected first Wi-Fi RSSI of the user device, and
sample, based on the classification result, a first Wi-Fi RSSI-second Wi-Fi RSSI pair to be included in the filtered dataset.

15. A non-transitory computer-readable recording medium having recorded thereon a program for executing, on a computer, the method of claim 1.
